(19) United States
(12) Patent Application Publication
(10) Pub. No.: US 2004/0024692 A1
(43) Pub. Date: Feb. 5, 2004

(54) Counterparty credit risk system

(76) Inventors: Wallace C. Turbeville, New York, NY (US); J. Scott Perry, New York, NY (US)

Correspondence Address: Peter D. Aufrichtig, Aufrichtig Stein & Aufrichtig, P.C., 300 East 42nd Street, 5th Floor, New York, NY, 10017, US

(21) Appl. No.: 10/354,941

(22) Filed: Jan. 30, 2003

Related U.S. Application Data
(63) Continuation-in-part of application No. 09/795,788, filed on Feb. 27, 2001.
(60) Provisional application No. 60/352,986, filed on Jan. 30, 2002.

(51) Int. Cl. G06F 17/60

(52) U.S. Cl. 705/38

(57) ABSTRACT

A method for managing, on a pooled basis, the credit risk coverage of contract performance by contracting parties. An aggregate maximum credit risk coverage for all contracts by each contracting party is established. Pools are defined into which contracts from various contracting parties may be aggregated. A credit risk coverage limit is defined for each of the pools. When a contract is entered into the credit risk coverage associated with that contract for each contracting party is calculated and it is determined whether that credit risk coverage plus the risk coverage associated with all other existing contracts of that contracting party are within the maximum credit risk coverage for that contracting party. That determination is then used to decide whether to accept the contract in the pool. The invention is particularly suited to the use with products and services which are illiquid or difficult to inventory, such as electrical power, forestry products and chemical products. The invention is also directed to a delivery logistics system and receivables funding system.

A method for managing, on a pooled basis, the credit risk coverage of contract performance by contracting parties. An aggregate maximum credit risk coverage for all contracts by each contracting party is established. Pools are defined into which contracts from various contracting parties may be aggregated. A credit risk coverage limit is defined for each of the pools. When a contract is entered into the credit risk coverage associated with that contract for each contracting party is calculated and it is determined whether that credit risk coverage plus the risk coverage associated with all other existing contracts of that contracting party are within the maximum credit risk coverage for that contracting party. That determination is then used to decide whether to accept the contract in the pool. The invention is particularly suited to the use with products and services which are illiquid or difficult to inventory, such as electrical power, forestry products and chemical products. The invention is also directed to a delivery logistics system and receivables funding system.

This application is a continuation-in-part of copending prior application Ser. No. 09/795,788 and claims the priority of Provisional Patent Application Serial No. 60/352,986 filed on Jan. 30, 2002.

### BACKGROUND OF THE INVENTION

The invention is generally directed to a method for managing, on a pooled basis, the credit risk coverage of contract performance by contracting parties. The system is particularly useful in connection with sale of products and services to allow sellers to, among other things, manage more efficiently the future utilization of their production capacity and buyers to manage their supply of industrial inputs dynamically. The method can support trading of products that are generally illiquid and difficult or impossible to inventory. The system can be accessible on an Internet-based platform as well as other platforms and creates liquid, tradeable, fully anonymous contract units which can be standardized for counter-party risk of physical delivery under established industry practices.

The invention is also directed to a logistics optimization system to minimize the total costs of shipping or transportation of products traded in the reduced risk trading system of the invention.

The invention is also directed to a receivables funding system in which a seller is able to receive payment at the time of the transaction even if delivery of the products are at a future date.

Traditionally, various products which were commonly available in standardized forms, quantities and qualities were marketed as commodities in which a buyer readily accepted the commodity in the standardized forms, quantities and qualities independent of the source or identity of the producer. The commodities could then be traded in a market or exchange. The exchange would impose rules on the underlying products themselves and on the form of the transaction. These rules controlled payment, location of payment, time and location of delivery of the commodity and dispute resolution procedures.

Two well known forms of exchanges are the stock exchanges (such as the New York Stock Exchange, American Stock Exchange and NASDAQ) and commodities exchanges (such as the New York Mercantile Exchange and New York Metals Exchange). The stock exchanges trade only in shares of stock of companies who pay for their stocks to be listed and traded on an exchange. In return, the companies are required to follow numerous rules imposed by the exchanges and other rules imposed by government regulators and statutes. For example, the NYSE rules require that member companies must issue financial reports in accordance with established and uniform accounting procedures. Similarly, there are rules for the settlement of trades by the seller producing the stock certificate or other indicia of the ownership of the agreed upon number of shares of the stock and by the purchaser in making payment to the seller. The regulations also provide methods of resolving disputes between sellers and purchasers and between exchange operating companies (brokerage companies) and their customers who use the operating companies to execute their purchase and sales.

Similarly, in the commodities markets there are rules relating to delivery, payment and dispute resolution. However, the delivery rules are necessarily more specialized as the commodities being traded and delivered are physically larger and more difficult to transport. Commodities such as gold, petroleum products, orange juice, pork bellies (bacon) and various other metals, agricultural products and raw and processed natural resources require specific rules relating to delivery, quality and specification establishment, testing and assurance.

Through the procedures in force companies, involved in the manufacture, growing, processing, use and sale of these commodities and companies whose products or services require these commodities as a component of their products or services, can use the exchange as a way to minimize price fluctuations in the supply or demand for their products by purchasing the right to purchase or sell product at a specified price at a specified date at a specified delivery point. In this way, for example, a coffee manufacturing company can purchase contracts for future delivery of coffee beans to assure itself of a steady supply of products at a known cost so that it can enter into long term supply contracts for its finished coffee products without being forced to absorb the market risk if the price of the raw material (coffee beans) rises sharply. Similarly, producers can sell their future crops to obtain payment to finance their farming and harvesting operations and protect against fluctuations of the market price. This type of exchange deals in contracts called futures contracts which are the right to buy or sell a commodity for a fixed price at a date in the future at a fixed delivery location.

Futures trade arrangements within the stock markets are called options and are a contract right to purchase or sell a block, generally 100 shares, at a strike price either by or on a certain date in the future. The option contract has a price associated with it based on the current price of the underlying stock, the strike price associated with the option contract and the expectation of the movement of the price of the underlying stock between the trade date and the date on which the option must be exercised.

Generally, in the commodities exchanges there is no provision for immediate trades, and all of the contracts are offered as futures contracts of varying lengths, generally associated with a particular month, such as December 2001 Gold or July 2001 Pork Bellies. The member firms of the exchanges, which make the markets execute the trades on behalf of their customers, provide services in handling the administrative aspects of the transaction and coordinating the transfer of funds between the buyer and seller, who often and generally don't know or care who the other party is.

One result of trading on traditional exchanges is that, because the rules governing the exchanges standardize the terms of the transactions, parties may trade on the exchange without knowing the identity of the other party(s) to the trade. This anonymity of counter-party is an important element of the exchange's ability to increase the liquidity of trading in a commodity and thus provide a generally lower and more stable price than would exist if all trades required a direct relationship between buyer and seller. If a market participant is indifferent to the identity of its counterparty, all participants are potential buyers and sellers and prices do not vary based on the credit quality of the participant.

Another aspect of the anonymity is the manner in which this allows different types of market participants to all function without disparate treatment. That is, those who i)expect or may be interested in either delivering or taking delivery of the actual physical commodity, ii) hedge against their business risks or iii) speculate or trade commodity contracts on the hope of profiting from the movement of the contract price, all operate according to the same rules without distinction. In this way, the anonymity of the exchange increases the liquidity of the market for the individual product.

While the commodities markets have been successful in improving liquidity and reliability of trading for the subject commodities, there are many more products which have not been traded on exchanges because of the nature of the products, the delivery problems, or other special factors. However, many of these industries (in particular electrical power, forestry products, specialized chemical products), have experienced severe price fluctuations resulting from the absence of liquidity in the marketplace and no reliable system other than direct bilateral agreement between producer and purchaser to establish forward supply planning. As a result, there is a need to establish a trading system and method which can facilitate liquidity and reliability for these products which are not sufficiently uniform enough to be traded as commodities on established exchanges. There is a need for a method of commoditizing products, such as energy, forest products and chemicals in such a way that allows uniform futures contracts to be traded. Such a system will promote market liquidity and price stability in the product market.

### SUMMARY OF THE INVENTION

The invention is generally directed to a method for managing, on a pooled basis, the credit risk coverage of contract performance by contracting parties. An aggregate maximum credit risk coverage for all contracts by each contracting party is established. Pools are defined into which contracts from various contracting parties may be aggregated. A credit risk coverage limit is defined for each of the pools. When a contract is entered into the credit risk coverage associated with that contract for each contracting party is calculated and it is determined whether that credit risk coverage plus the risk coverage associated with all other existing contracts of that contracting party are within the maximum credit risk coverage for that contracting party. That determination is then used to decide whether to accept the contract in the pool. The invention is particularly suited to the use with products and services which are illiquid or difficult to inventory, such as electrical power, forestry products and chemical products. The invention is also directed to a delivery logistics system and receivables funding system.

Accordingly, it is an object of the invention to provide an improved system for standardizing contracts for products and services to make their trading more like a commodity.

It is a further object of the invention to provide an improved logistics optimization system to minimize the total costs of shipping or transporting those products traded under the risk transfer conduit system based on contracts.

Still another object of the invention is to provide an improved business-to-business virtual market for trading of products not currently tradable as commodities.

Another object of the invention is to provide a system whereby market participant credit facility availability and exchange risk exposure is calculated to manage pooling and transfer of risk.

Still yet a further object of the invention is to provide a calculation of a product forward index using market sampling, market canvassing and liquidity factors.

Still another object of the invention is to generate hedging position data to identify and implement hedge positions which will optimize the value of the exchange's risk portfolio.

Yet still a further object of the invention is to provide a risk transfer conduit system to trade electricity contracts.

Yet still another object of the invention is to provide a risk transfer conduit system to trade forest products contracts.

Still other objects and advantages of the invention will, in part, be obvious and will, in part, be apparent from the specification.

The invention accordingly comprises the features of construction, combinations of elements, arrangements of parts, steps, procedures and methods of operation which will be exemplified in the constructions and processes as hereinafter set forth, and the scope of the invention will be indicated in the claims.

### BRIEF DESCRIPTION OF THE DRAWINGS

For a fuller understanding of the invention, reference is had to the following descriptions taken in connection with the accompanying drawings, in which:

FIG. 1 is an illustration of a computer system constructed in accordance with an embodiment of the present invention.

FIG. 2 is an illustration of a program for allocating risk in accordance with an embodiment of the present invention.

FIG. 3 is a graphical representation of a bilateral separately negotiated contract without aggregation of risk in accordance with the prior art;

FIG. 4 is a graphical representation of an electronic exchange structure with risk transfer;

FIG. 5 is a graphical representation of a transmission example in the electricity contract market constructed in accordance with a preferred embodiment of the invention;

FIG. 6 is a graphical representation of a portfolio based evaluation of portfolio risk and securitization of the credit risk through allocation of insurance and risk retention in accordance with a preferred embodiment of the invention;

FIG. 7 is a graphical representation of the transportation of forest products through a delivery node in Montreal, Quebec, Canada from buyers to sellers using a system of commoditization in accordance with the invention;

FIG. 8 is a graphical representation of the transportation of forest products set for through a delivery node in Montreal, Quebec, Canada in accordance with the logistics optimization system in accordance with the invention which reduces transportation expenses; and

FIG. 9 is a chart showing Mark-to-Index Coverage versus Liquidity Coverage;

FIG. 10 is a flow chart diagram showing the Netting Process in accordance with a preferred embodiment of the invention;

FIG. 11 is a chart showing liquidation of VMAC covered contracts and payment of covered exposures;

FIG. 12 is a chart showing VMAC netting and exposure;

FIG. 13 is graphical chart showing possible price movements;

FIG. 14 is a chart showing the VMAC system's net liquidity exposure to A for different Products;

FIG. 15 is another chart showing the VMAC system's net liquidity exposure;

FIG. 16 is another chart showing the VMAC system's net liquidity exposure;

FIG. 17 is a flow chart diagram showing VMAC database clearing;

FIG. 18 is a flow chart diagram showing VMAC system electronic Platform Processes;

FIG. 19 is a flow chart diagram showing VMAC trader to trader processes;

FIG. 20 is a flow chart diagram showing VMAC brokered trades processes;

FIG. 21 is a flow chart diagram showing VMAC contract confirmation processes;

FIG. 22 is a flow chart diagram showing VMAC credit clearance processes; and

FIG. 23 is a flow chart diagram showing VMAC credit check processes.

### DETAILED DESCRIPTION OF THE PREFERRED EMBODIMENTS

The invention is generally directed to three unique financial systems to transfer credit risks from electronic and conventional exchanges and to enable the creation of a virtual market for business-to-business trading of products and services which have previously not been tradable on a commodity exchange. A risk transfer conduit system is at the core of the financial systems and creates the opportunity for the application of the other two systems, a logistics optimization system and a receivables funding system. The financial systems are appropriate for use in connection with existing and planned electronic, Internet and over-the-counter marketplaces, as well as traditional exchanges.

The risk transfer conduit system is used to reduce or eliminate counter-party risk in contracts which may be traded in over-the-counter transactions, on electronic exchange platforms or on conventional exchanges. Counter-party risk is defined as the risk to a party from the non-performance of the party to a contract for the purchase and sale of a product. For example, the counter-party risk to a seller is the risk that the buyer does not take and/or pay for the goods or services in accordance with the contracted conditions. The counter-party risk for the buyer is the risk that the seller will not deliver the required goods or services in accordance with the contracted conditions, such as the required time and location.

The logistics optimization system was developed to minimize the total costs of shipping or transportation of those products traded under the risk transfer conduit system. This is done, as described below, by evaluating a portfolio of contract trades and then optimizing the delivery costs by pairing up the buyers and sellers, whose identities are not known to each other, in a fashion which reduces the overall shipping costs for all deliveries.

The receivables funding system allows sellers of products traded under the risk transfer conduit system to receive immediate payment for the sale of products for delivery at a future date. This is enabled by the financial planning and securitization of the process established by the risk transfer conduit system.

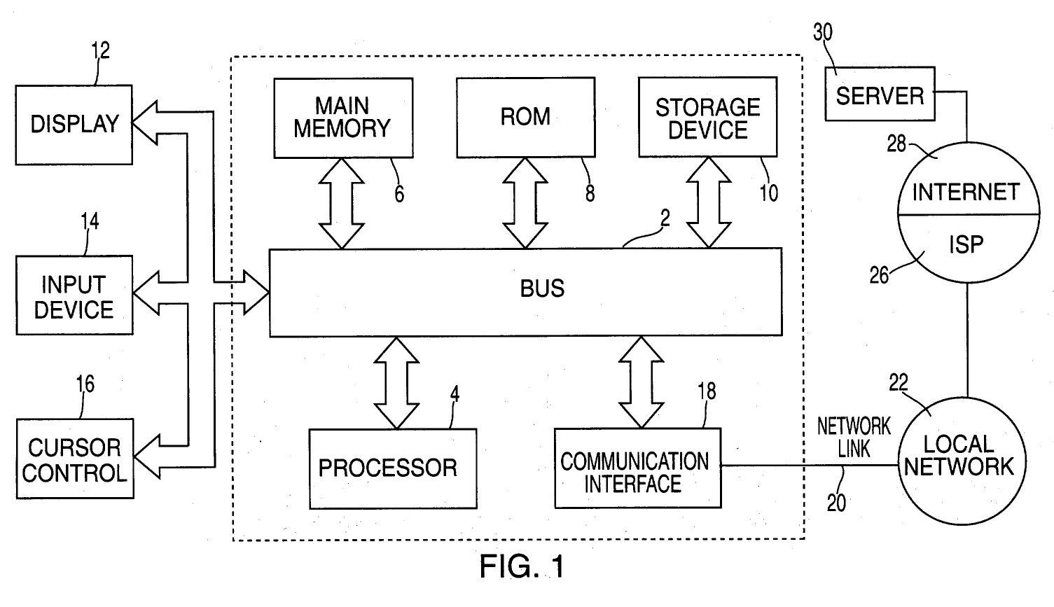

Reference is made to FIG. 1 which illustrates a computer system for carrying out the method of the present invention. The computer system includes a bus 2 for communicating information coupled to a central processing unit 4, main memory 6, read only memory (ROM) 8, digital storage 10 and communication interface 18. The bus 2 is also coupled to a display 12, input device (e.g., keyboard) 14 and cursor control 16. The computer system operates through the execution of instructions by the processor 4 which are retrieved from main memory 6, ROM 8 or digital storage 10. Generally, main memory 6 stores a program of instructions which the processor 4 executes in combination with input data retrieved from ROM 8 or digital storage 10. The computer system may also receive data (or other instructions) from other computer systems which transmit such information to the computer system over the communication interface 18. The communication interface 18 is generally coupled to a local network 22 which is coupled to an Internet service provider (ISP) 26 that connects to the Internet 28 and eventually to other computer systems through server 30.

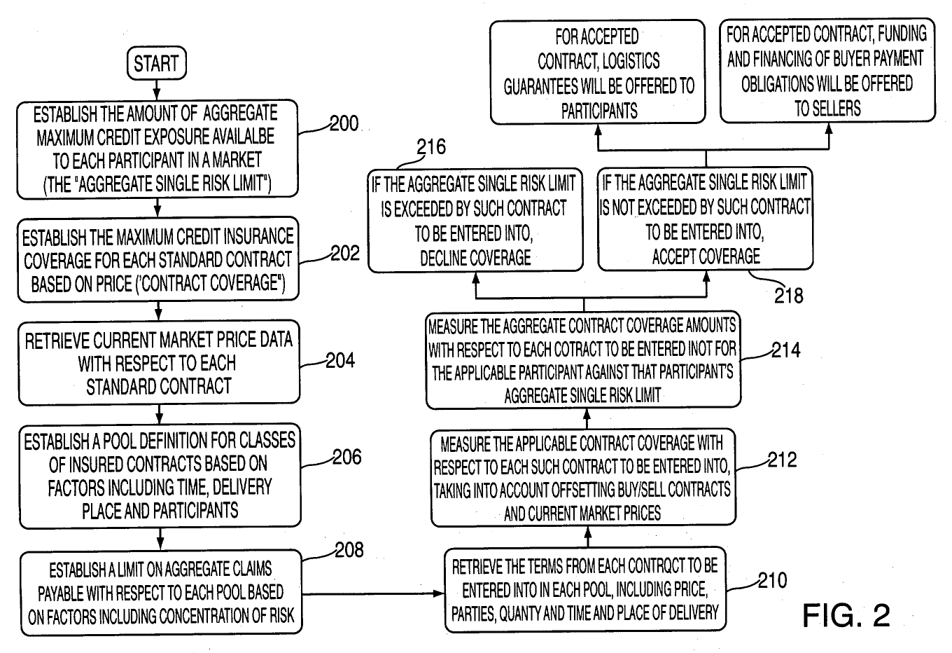

FIG. 2 illustrates a program of instructions which operate on the computer system 10 for carrying out the method of the present invention. In particular, the program illustrated in FIG. 2 implements a system for trading electrical energy. As a product, electrical energy is traditionally illiquid because electrical energy cannot be efficiently stored on the scale necessary to supply major markets such as California. Once electrical energy has been generated, it must be delivered, and conversely, when electrical energy is to be delivered it must be generated. Traditionally, then, buyers and sellers of electrical energy make individual arrangements to coordinate delivery of a certain amount of electrical energy at a specified time for a price to be paid at a later time after delivery, or generating companies agree to service grid operating entities through a system of spot markets.

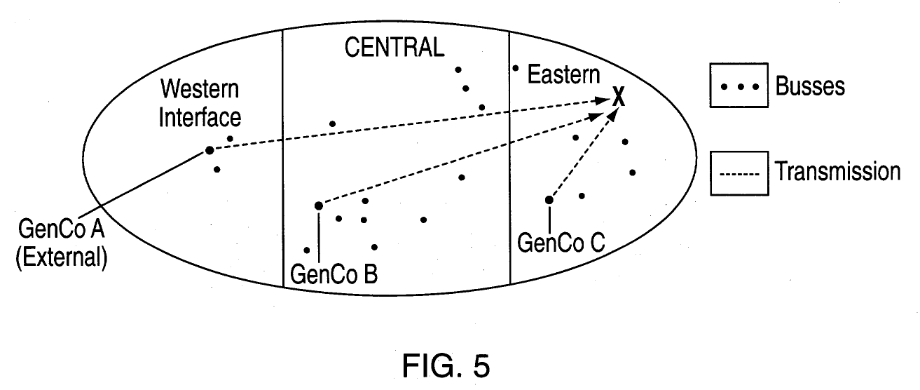

As shown in FIG. 5, for example, load serving entity (LSE) X, in Independent System Operator (ISO) Eastern region, is to be delivered electrical energy. LSE X is indifferent to the actual entity that delivers the energy as long as the costs are the same. However, because generator company A and B are not within the Eastern ISO, their costs will generally be higher than C's. Moreover, generator capacity at specific times are other parameters that distinguish suppliers and lead buyers and sellers to rely on traditional individual relationships.

The program illustrated in FIG. 2 creates an alternative trading system for the electrical energy market. Initially, in step 200, an Aggregate Single Risk Limit (“ASRL”) is established. The ASRL is the maximum credit exposure available to each participant in the market. The ASRL may be different for each participant—that is, participant “A” may be allowed $X million of available credit (determined by an evaluation of collateral, past credit history, etc.) and participant “B” may be allowed $Y million of available credit. Then, in step 202, the Contract Coverage is established. Contract Coverage is the maximum credit insurance, based on contract price, coverage for each standardized contract. For example, a particular contract may be priced at $M but may be insured for a maximum of $N where $N is the Contract Coverage.

In addition to establishing the ASRL and Contract Coverage, the computer system 10 (FIG. 1) collects data concerning the current and future electrical energy market from a number of contract aggregators. Contract aggregators are exchanges or other entities which engage in entering into or matching contracts for the delivery of power. At any one time, such entities generate and maintain lists of contracts to supply energy to buyers (such as LSE X) from sellers (such as generator company A). Based on these contracts, a certain amount of electrical energy, for delivery at a certain place, at a certain time and price is supplied through a transmission system and monitored by the contract aggregators.

Through its network connections, the computer system 10 retrieves the data concerning the individual contracts from contract aggregators. Each Contract will be standardized for the delivery of a specific amount of power during a specific time period. In addition to specifying the month of delivery, the Contract Units will specify the day and time of day of delivery, allowing for 24 hour delivery 7 days a week for base load Units and 16 hour delivery during non-holiday weekdays for peak load Units. The following outlines an example structure of contract Units:

a. 10 MW Base load Units: these Units will represent the delivery obligation of seller for 10 MW each hour, 24 hours per day, 7 days per week for a specified month.

b. 5 MW peak load Units: These Units will represent the delivery obligation of seller for 5 MW each hour, 16 hours per day, weekdays excluding any holidays, for the specified month.

Standardization for delivery is achieved within the risk transfer conduit system by designing the Contract Units for specific delivery to a point within a managed grid such as an ISO such that transmission costs from any delivery point within the specified ISO area (as defined by the Contract Unit) to any buyer inside the same ISO, are equal. A buyer must be indifferent to the bilateral Power Contract counter-party from a locational standpoint, in order to be able compare the offer prices of different generation companies. The standardized delivery point becomes any point within the Contract Specific ISO area (or regional Contract area with characteristics similar to an ISO).

In step 204, using data collected from the contract aggregators, market pricing data for electrical energy contracts as a function of time, place of delivery and quantity is generated. In addition to the data collected from the contract aggregators, the computer system 10 also retrieves or receives other market information concerning the electrical energy market. For example, certain energy generating companies supply current and future anticipated market prices for electrical energy which is transmitted to the computer system 10. Also, computer system operators may input predictions of market prices made by industry analysts. This market information on the current and future price of electrical energy is combined with the data from the contract aggregators (through averaging or other standard statistical techniques) in step 204 to produce estimates of current market prices for electrical energy for certain delivery amounts at certain times to specific geographical areas. Estimates of future market prices are also produced. At any one time then, the trading system operating according to the program illustrated in FIG. 2 tracks its best estimate of the market price for electrical energy on a current basis and over future time periods.

In step 206, a pool definition is established. A pool aggregates those contracts which are to be insured as a group. Pooling the contracts reduces the effective allocated risk on any one contract. That is, because it is statistically unlikely that all contracts in a group will not be performed, the overall risk of non-performance at any one time for the group is less than the individually allocated risks. Accordingly, because the effective risk of the portfolio is reduced, the portfolio is insured for a premium that is less than the sum of individual premiums that would be required for each individual contract, even though each individual contract is fully insured.

Commonly, the pool definition groups energy contracts according to delivery region. For example, all buyers and sellers of energy contracts having delivery in the Northern California hub may be treated as pool “1”. A variety of different pool definitions based on delivery time or interval, place, quantity and/or participant designation may be established. Once pool definitions have been established, a pool limit is established in step 208. A pool limit is the maximum amount of insurance payable with respect to each pool. That is, the total insurance payable for any one pool will only be a fraction or set percentage of the total value of the contracts in the pool. Any one contract (or subset of contracts) may be fully insured as long as the total limit for the pool is not exceeded. To the extent the pool limit is exceeded, individual contracts may not be fully insured. The pool limit is established based on the characteristics of the pool (delivery location, delivery history, participants, etc.), including the concentration of risk in any one (or small number of) participants.

After the pools have been defined and appropriate pool limits established, the standardized terms from each contract entered into, in each pool, are retrieved in step 210. As noted above, these contract terms are available from the contract aggregators. The standardized terms retrieved for each contract are i) buyer/seller designation, ii) price, iii) quantity, iv) delivery time and/or interval, and v) delivery place and/or region. Once the information associated with steps 200 to 210 has been gathered, the applicable contract coverage with respect to each contract in the pool is measured in step 212. Measuring the contract coverage consists of determining the financial loss which would occur n the event a party to the contract fails to perform under the contract. This determination of financial loss takes into account the current and expected market prices (depending on delivery date) for the energy delivered to the contract delivery point at the delivery time, as well as the contract price. It also takes into account offsetting buy and sell contracts for energy. The measurement 212 of the contract coverage occurs on a real time basis as new information concerning the market price is available.

Once the contract coverage has been measured in step 212, it is compared against the maximum limit for each contract (i.e., “Contract Coverage”) and against the limit of contract coverage for each participant (i.e., “ASRL”) in step 214. If the measured contract coverage falls within the ASRL and contract coverage, the contract will be accepted and insured in step 216. If the measured contract coverage is outside of the ASRL or Contract Coverage, it will not be accepted in step 218. Because the system of the present invention automatically makes the determination of whether to accept (or not) energy contracts as they are presented based on the latest market data, the exposure to the insurer can be more easily managed within the pool limits, and hence, the stability and liquidity of the energy market enhanced.

Once the contracts have been insured, the trading system of the present invention monetizes the transactions. The transactions can be immediately monetized because the delivery obligation and the unfunded payment obligation of the transaction has been insured from the date of the contract. The delivery obligation refers to the sellers obligation to deliver an amount of energy to place at a certain time. The payment obligation refers to the buyer's obligation to pay a certain price for delivery of energy. Traditionally, although the delivery obligation could be insured (albeit at a higher rate than according to the present invention), the payment obligation was not insured until after the delivery date. In the present system, the payment obligations are pooled and insured just as the delivery obligations were pooled. The pooled payment obligations are insured from the contract date. Because the entire transaction, delivery and payment obligations, are insured from the contract date, the transaction can be monetized (i.e., add) immediately. That is, the electrical energy contracts can be bought and sold just as other commodities contracts.

The risk allocation methods used in implementing the program of FIG. 2 are also generally applicable to markets other than electrical energy.

The risk transfer conduit system acts as an intermediary to transfer all or a portion of these counter-party risks from these electronic exchange systems and conventional exchanges to the capital, insurance and re-insurance markets. The risk transfer conduit system provides assurance to both buyers and sellers, as well as to financial participants in hedging contracts. It assures a seller of a product or service in a business-to-business marketplace that it will receive payment at the contracted price. The reasons for nonpayment are numerous including unwillingness to take the goods or services, inability to pay due to financial straits, a dispute relating to the contractual conditions including delivery, quality, quantity or other terms of the contract. This risk is generally equal to the contract price.

The system assures a buyer of a product or service in a business-to-business marketplace that it will be delivered that product or service under the contracted terms subject to a cap on losses in the event of seller default. The risk to a buyer in a transaction is the risk that the seller does not perform. In this case the risk is calculated as the difference in the contract price under which the seller had promised to deliver, and the cover price, which is the price a buyer must pay to replace the non-delivered goods or services at the contracted time for delivery.

The system further assures each counterparty of a financial hedging contract of the performance of the other party. Performance in such a case is payment at a date of a sum based on then current prices for the subject product and the terms of the contract. This system would provide for a capped assurance to each side.

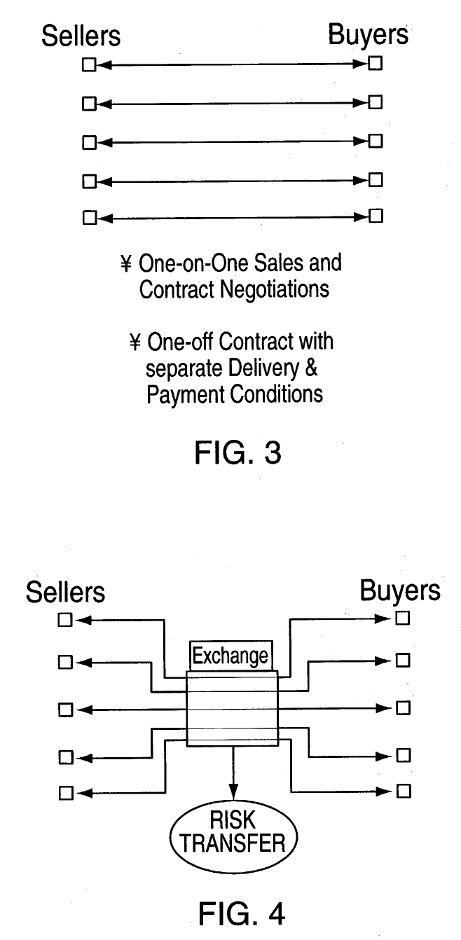

Prior to electronic exchange systems, counter-party risk related to contracts for the purchase and sale of most goods and services (i.e.—goods and services other than goods traded on traditional, organized commodity exchanges, described below) and ran exclusively between parties. It was not intermediated by any institution or market space. Reference is made to FIG. 3 where a graphical representation of this type of non-intermediated transaction in accordance with the prior art is represented. Since these transactions were not intermediated, they were not aggregated by any party. In addition, contracts for these classes of goods were not uniform and parties sought performance assurance through an analysis of an individual counter-party's credit-worthiness or through financial guarantees such as letters of credit and performance bonds. This type of transaction required a seller to locate a specific buyer and negotiate the terms of the sale transaction on a one-to-one basis. While each seller generally had its standard form of contract, each buyer typically had its own form of purchase order with terms and the law of contracts and particularly the Uniform Commercial Code dealt with the sale of goods between merchants in Article 2 which has the subject of a multitude of litigation. Other types of transactions of this sort were dealt with under general contract principles. This approach, while certainly workable, limits the ability of sellers to find and deal with buyers and buyers ability to deal with a wide selection of sellers. Generally, sellers needed to assure themselves that the buyers were serious, reliable and financially able to make the payment when delivery of the goods or services was made. Similarly, buyers had to satisfy themselves that the sellers were capable of producing or acquiring the goods or services they were to deliver and reliable in executing such performance. In addition, when buyers would buy similar goods from different vendors there was no likelihood that the terms of the agreement would be the same or that the other parameters would be similar. Certainly, this approach increases the administrative cost of the sale transaction on both sides and makes insurance against counter-party risk the willingness to litigate or arbitrate a claim between the parties. As important is the absence of liquidity in the market and the ability to quickly and easily locate a market price which other participants will buy and sell the products for without significant effort.

Certain fungible and easily storable goods, typically referred to as “Commodities”, have often been bought and sold via organized exchanges rather than through bilateral transactions described above. These exchanges matched offers to sell with offers to buy, thereby permitting anonymous trading and uniform credit. A principal advantage of the exchange system is liquidity. Since contracts are anonymous and uniform, parties can liquidate their positions without extensive negotiation and at a more predictable price. Elaborate collateral systems were developed for use by these exchanges to assure participants that their interests would be protected in case of a default by other participants. Reliance on a collateral system for exchange participant security is reasonable when certain conditions exist. These include uniform pricing and liquidity of trading. Uniform, transparent and discernable spot market pricing of the commodity for future delivery allows the exchange to calculate accurately the amount of collateral required to keep counter-parties whole under pricing conditions that obtain at the time of calculation. These collateral requirements are generally known as margin requirements which require a market participant to have sufficient equity to meet some specified percentage of the value of its contracts. A liquid market for forward purchase and delivery contracts is essential so that, in the event of a default prior to the delivery date, the exchanges can readily find a party to assume the defaulting party's position in the contract, before market moves could make the collateral on hand insufficient. These conditions are attributes of traditional “Commodities”. However, other goods and services are now capable of being trading on a similar basis in accordance with the systems of the applicants' invention in a business-to-business virtual market.

With the advent of electronic exchanges, businesses now contract with each other online or through other electronically-aided means for the purchase and sale of goods and services that are not traded on traditional, organized exchanges. The mechanics of transacting trades of non-commodities and the typical terms of sale are converging with those applicable to Commodities exchanges. For instance, the counter-party risks involved in a non-commodity trade now exist in definable locations, i.e. the online sites or other electronic media for business-to-business trading. Reference is made to FIG. 4 wherein a business to business electronic exchange is shown graphically. Business-to-business exchanges have attempted to implement various credit assurance mechanics to imitate the anonymity and uniformity of commodities exchanges. However the nature of the goods and services sold render these methods uneconomical and/or unworkable. Generally, these systems examine each transaction by itself and attempt to securitize the transaction. This has the result of either failing because the securitization is inadequate or restricting the ability of parties to deal such that there is no meaningful improvement over the non-aggregated non-intermediated model of FIG. 3.

The counter-party credit transfer conduit system is a unique conduit system to transfer aggregated counter-party credit risks from the electronic marketplace to the insurance, reinsurance and credit-derivatives markets. Transfer to one or more of these markets is known as syndication The method aggregates contract performance risks by tracking them via its method of operation (described below) and insuring these risks on a portfolio basis. Specifically, the system treats the electronic market place as a focal point for the aggregation of Contract Performance Risks, permitting the capture of those risk pools. Each risk pool is analyzed as a portfolio of risks representing contract performance obligations which exist during discrete time periods.

The risk transfer conduit system is structured such that it is applied to each trade in a market, and the resulting coverage of a high number of performance and credit risks are treated as a portfolio of risks. This achieves a pricing benefit for the consumer (which in this case is either user of the marketplace, i.e. buyer or seller). It provides the ancillary benefit of liquidity which will attract market participants who will use the market to hedge their operations (something not available to them in bilateral arrangements or existing electronic sites). Other ways to provide contract performance assurance exist, such as bank letters of credit and individual event insurance policies, but these methods are more expensive, and are handled one client and/or one transaction at a time.

It is important to note that the benefits of the risk transfer conduit system are automatically provided to both buyer and seller when they consummate a trade on a risk transfer conduit system enabled system. If either party defaults, that position is covered by security provided by the system and the performing counter-party remains unharmed.

The approach to counter-party risks in accordance with the invention is unique in that it treats market activity as a portfolio of credit risks. While each contract is covered up to a limit considered adequate by Buyers and Sellers, total claims in respect of a portfolio are limited. Using statistical analysis of the risk portfolios, the system operators can limit the system's coverage to a percentage of the portfolio based on expected loss scenarios, thereby limiting the cost of coverage.

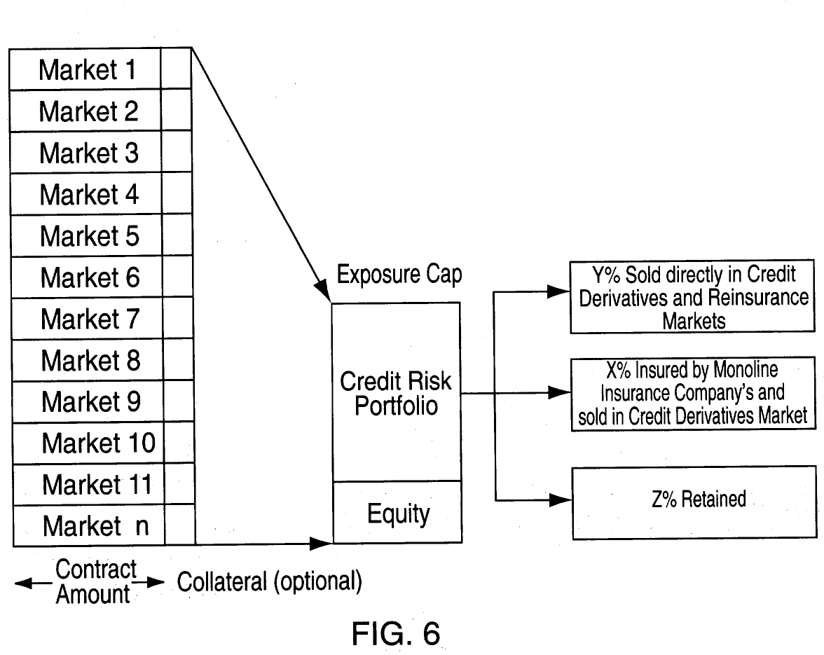

Reference is made to FIG. 6 wherein a graphical representation of the manner in which the risk portfolios are established and the credit risk portfolio sold to others (with the possibility of retaining some percentage) is depicted.

In the example of FIG. 6 the credit risk portfolio includes an equity component and a credit risk portfolio up to the exposure cap. The exposure cap is established in the system so that the system need only pay the actual damages of a party from its counter-party's lack of performance up to some limit, generally a percentage (which may be greater than 100 percent) of the contract price. Then, the credit risk portfolio is secured by the system when it sells of pieces of its risk exposure to insurers. In the example of FIG. 3 some percentage (Y %) is sold directly in credit derivatives and reinsurance markets, another percentage (X %) is insured by monoline insurance companies and sold in the credit derivatives market, and the remaining percentage (Z %) is retained by the system as its own risk, secured by its equity. Depending on the market place and the financial goals and resources of the system, the varying percentages, and the sale of the risk to other markets is set by the system's management. However, from the seller or buyer's perspective, this reinsurance structure is irrelevant. The seller or buyer merely knows that in the event of non-performance by its counter-party the system will make good on the sale up to the exposure cap for a transaction and that the system's credit is satisfactory.

The risk conduit transfer system in accordance with the invention is an alternative to the one-by-one credit analysis of the traditional business-to-business bilateral contract and to the collateral-based system used by traditional exchanges. In each of those approaches, the credit focus is on each individual transaction. The current system uses portfolio analysis to limit the coverage in a more cost effective way. The coverage structure also provides more effective assurance than the collateral system.

The current system in accordance with the invention can also be employed in tandem with a collateral-based system, since both are designed to provide assurance in the context of anonymous, standardized contracts. In this type of application, contract performance assurance would be used in lieu of collateral or financial guarantee instruments procured by participants since it is less expensive and more reliable than collateral or diverse financial guarantees. Collateral would be used by participants that do not qualify under portfolio standards and for trading by approved companies in excess of aggregate maximum credit risk coverages. In this application, such additional collateral might be arranged between the market participant and the system operators, rather than between the party and its counter-party.

The performance obligations insured will derive from contracts for the purchase and sale of goods and services and from financial hedging transactions. The key terms in a contract for purchase and sale will include: quantity of item or service sold; price and terms for payment; time required for delivery (depending on the good or service, it could be a specific time, delivery over a period or delivery at a time within a period); place of delivery (typically a transport hub so that contracts will be uniform and not dependent on actual points of origination or destination, e.g., X product delivered at Y hub); and quality specifications for a product or service.

The seller's obligations will be to deliver the specified goods or services at the time and place stipulated. If the seller fails in performing that obligation the system operators may be entitled to perform on the seller's behalf. In most cases the system operators will however, be able to purchase another contract to cover the obligation to deliver. If it is impractical to perform on the seller's behalf, the contract of assurance will assure payment of the lesser of the actual cost of covering failed performance or a specific contract-related cap, based on the contract price. This obligation may also be limited by a limit on aggregate losses on the entire pool of risks of which the contract is a part. Each seller will provide an indemnity to the system operators or otherwise assure repayment of amounts paid under the system operators contract of assurance.

The buyer will be required to pay a purchase price upon performance by the applicable seller or by the system operators on behalf of that seller. Upon non-performance by a buyer the seller will be paid the amount required to cover losses in price received for the goods or services, up to a contract-related cap. This obligation will also be limited by a limit on aggregate losses on the entire pool of risks of which the contract is a part.

Each seller will provide an indemnity or otherwise assure repayment of amounts paid under the contract of assurance. Each buyer will provide an indemnity or otherwise assure repayment of amounts paid under the contract of assurance. Covered parties in financial hedging contracts will provide an indemnity or otherwise assure repayment of amounts paid under the contracts of assurance.

When a party signs up to participate in a risk transfer conduit system enabled market trading system, it will enter into two separate agreements before it can conduct any trades on the system. The first is a master bilateral purchase/sale agreement. The second is a master credit facility.

The master bilateral purchase/sale agreement constitutes the standardized bilateral contract for all trades undertaken by a market participant and outlines the basic terms and conditions of the sale and purchase of the product. When a seller offers a quantity of product in the market, Price, Delivery Date and Delivery Place will be specified. If a buyer bids for and buys the product, these offered terms, together with the general contract terms of the Master Bilateral Agreement constitute a legally binding contract between parties who remain anonymous to each other. The master bilateral contracts may be devised jointly with entities other than the system operators. Generally, different terms may be established for different types of products and services, with terms familiar to the industry involved.

Under the master credit facility, the terms and conditions of a credit assurance facility (the “Facility”) which will cover buyer and seller defaults is entered into as a condition, or option, of participation in the market. This Facility will outline the costs of basic coverage, the terms of payment, the payment caps, credit requirements necessary for participation and actions taken in the event of the occurrence of a credit event by a participant. Similar to the master bilateral agreement, when a trade is consummated between market participants, a contract purchase price, delivery date and delivery place are defined in the Facility and a binding legal agreement is entered into between: the Buyer and the system operators (or a designated Credit Facility Provider); and the Seller and the system operators. The contract between the buyer and the system has the buyer guaranteeing payment of its contractual obligation, agrees to pay a transaction fee to the system operators, and receives assurance from the system of delivery of the contracted product subject to certain limitations.

In the case of the seller's contract with the system, the seller guarantees the system full payment of the cost of covering the contract, which will be the cost of the replacement goods in the spot market, submits to pay a transaction fee, and receives assurance from the system for the payment by the buyer, subject to certain limitations.

In order to transact on an exchange in contracts assured by the system in accordance with the invention, participants must be approved by the system. The aggregate maximum credit risk coverage will limit the amount of exposure to the participant's credit which will be accepted by the system. Credit exposure will be based on the total price of contracts assured by the system that are outstanding and that involve the participant. The participant will not be permitted to trade beyond this limit unless an increase is granted by the system or some pre-arranged collateral or credit enhancement is provided by the participant.

The system will assess its exposure to a participant on all systems covered by system assurances and will analyze offsetting positions in establishing limits and calculating exposure. For instance, a participant that agrees to sell a quantity of a product at a given time and place on Exchange A, and agrees to buy the same quantity of the same product at the same time and place on Exchange B, may have a net zero exposure to the system if the price of contracts is the same. Alternatively, contracts will be netted, across exchanges if necessary, under the methodology described below.

To make the risk conduit transfer system operate there must be a reliable method of capturing risk and gathering data. The system connects directly to an electronic exchange, and receives the following data on a real time basis: participant bids and offers on specific contracts; matched trades, reflecting offers and bids which are matched and which create contractually binding obligations on a buyer and seller; outstanding bids and offers of each participant which are compared and matched when they are for the same price; and matched trades in which participants have a position within the aggregate maximum credit risk coverage placed on the particular participant by the system's Credit Management Department. The system then sends in real time an approval code to the electronic market, which will then manage the participants as they enter bids and offers.

Although the system manages its exposure to any particular participant, the system does not underwrite each contract counter-party individually. Rather, the risk conduit transfer system in accordance with the invention aggregates contracts into Predefined Pools and insures the pooled risk. This approach to transferring risk (through insurance) from an entire electronic marketplace is an entirely new approach to achieving counter-party security within such a market.

Each contract within a Predefined Pool is insured up to a percentage value (which may be greater than 100%) of the Contract Price (the “credit risk coverage limit”). The credit risk coverage limit will be set by the system, and will vary according to contract and marketplace demands. Insurance covers damages related to a non-performance of both the Seller and the Buyer. In addition to designating the Credit risk coverage limit, the system designates a total cap for the Predefined Pool (the “Pool Cap”).

The Pool Cap represents the total maximum exposure covered by the system for a particular Predefined Pool, and is set by the system and will vary according to each Predefined Pool and marketplace. This unique function of the risk conduit transfer system allows for an extremely competitive pricing structure.

The risk conduit transfer system software calculates the total exposure in the Predefined Pool on a real-time basis, storing this data in a main system database. Each matched purchase and sale contract adds exposures on each side of the transaction to the total exposure in the predefined pool.

The risk conduit transfer system compiles the total exposure of the Predefined Pools of risk for various contracts within various marketplaces. This portfolio of combined risk represents the risk which the system is transferring from the electronic markets. The system then segregates this risk portfolio into various risk tranches ranging from first loss equity positions to AAA-Insured positions (see FIG. 6 above). This is analogous to the tranches created in the securitization of loan portfolios. This placement activity is an ongoing process integral to the risk transfer conduit system operated in accordance with the invention.

Because the contract performance assurance covers each trade in a marketplace it creates a large portfolio of corporate credit risks on an ongoing basis. The contract performance assurance prices its insurance coverage based on this portfolio approach, and is therefore able to compete aggressively with banks and property and casualty insurers.

Once the contract performance program assurance of the risk conduit transfer system has created a critical mass of credit facility applications in its target markets, the system will initiate a process in which the credit risk associated with the contract performance assurance program master credit facility will be partially securitized and placed into either the insurance market, the reinsurance market or the credit derivatives market.

The system will develop its credit facility portfolio by either direct placement with AAA monoline insurers; or direct provision of the master credit facility. The system may decide to place credit risks generated under application of the contract performance assurance program master credit facility directly with a AAA monoline insurer, which will access the reinsurance market and credit derivatives market as required.

In the case of direct provision of the master credit facility, the contract performance assurance program would enter directly into the Master Credit Facility and would then periodically place the credit risks of that portfolio (together with any required system equity) into insurance, reinsurance or credit derivatives markets.

There are several aspects of risk management which the contract performance assurance program builds into its system, ranging from pre-screening to risk fee pricing. The process compensates the contract performance assurance program for covering the actual risks of a portfolio, and gives the market participants an adequate level of coverage at an attractive price.

In the event that a market seller fails to make delivery of the products contracted for, the contract performance assurance program will cover the difference between the Contract Price and the Cover (Spot market) Price, up to the Price Cap. The Price Cap will be defined in the Master Credit Facility as a percentage of the Contract Price. In the event that the Spot Price exceeds the Price Cap, the contract performance assurance program will retain the right to make a cash payment to the buyer in the amount of the difference between the Contract Price and the Price Cap, and the buyer will have the option to cover the contract at market prices.

In some of the target markets forward spot markets either do not exist or have poor liquidity. The system will manage an independent Product Forward Index (“PFI”) as a method of establishing a forward curve in the target market products for market participants. The PFI will be utilized by buyers, sellers and the contract performance assurance program to calculate their risk positions at various forward pricing points.

The system, or other operator of the contract performance assurance program will charge a basic fee for its coverage, equal to a percentage of the risks inherent in the contracts outstanding. This fee will be partially paid by the buyer in an amount equal to a percentage of the Contract Price or a percentage of the average PFI from contract initiation until the delivery date and partially paid by the seller in an amount equal to either a percentage of the Contract Price times the Coverage Period or a percentage of the average PFI from contract initiation until the delivery date. Payment of this fee will be partly up front and partly billed monthly in arrears on a balanced accounts basis.

The contract performance assurance program will establish minimum credit requirements for participation in the markets. These participation requirements shall be based on providing either one or both of a minimum credit rating from a recognized U.S. rating agency and a letter of credit from a bank, meeting the minimum credit rating requirement, in an amount equal to a percentage defined in the master bilateral contract.

The software for operating the risk transfer conduit system and the contract performance assurance program performs the following functions related to the business methods of the risk transfer conduit system: (1)data capture; (2)limit calculation; (3)calculating the risk transfer conduit system's exposure; (4)calculating a product forward index (PFI); (5)performing verification functions; (6)generating hedging position data; and (7)collecting and distributing administrative data.

(1) The data capture is performed via a dedicated data line or Internet connection to individual marketplaces and aggregations points of risk. The software system will capture: outstanding offers of a contract (from sellers); outstanding bids for a contract (from buyers); matched trades (which are outstanding contracts for which the delivery date has not yet arrived). All data pertaining to the contracts in question will be contained in the data capture. The relevant contract data will include: contract definition; offer price; bid price; and the matched trade price.

(2) The limit calculation in the software system will provide individual participant trade limits to electronic markets on a real-time basis. Limits will correspond to both total contract value and contract term and will take into consideration off-setting positions and positions in multiple markets. If a credit event occurs with regard to a participant, limits may be altered by the system software, and the risk transfer conduit system will automatically react to these alterations. The system software will automatically determine which, if any, contracts should be covered to reduce a participant's outstanding contract positions to new limit levels, and the software system will have a capability to execute such cover in the market. Generally, the software will notify an operator who will need to authorize such a cover operation.

(3) The software calculates the risk transfer conduit system's exposure. Based on data related to outstanding matched trades, the predefined pool definitions, individual contract coverage and overall limits on coverage of the predefined pool, the system software will calculate the maximum exposure of the entire risk transfer conduit system portfolio. Utilizing market pricing indices (which may be generated by the system software) the risk transfer conduit system's exposure to individual credits (market exposure)will be calculated. This information will be readily available to the system software.

(4) The calculation of a Product Forward Index (PFI) is performed by the system software which will track activity of the markets it covers and will receive additional data inputs regarding forward pricing. This price would be the price at which a given contract could be expected to trade on the day of calculation. The system will then calculate a Product Forward Index to be used in calculating exposure to individual entities. For instance, a contract for sale of product A for delivery six months from a given date would require a price of $X to induce the Buyer and Seller to agree when entered into, 3 months later because of market movements the required price would be $Y. One component of the PFI will be actual market sampling, comprised of automated downloads and analyses of market trades of the contracts in question on the date of the calculation of the PFI for such contract. These market observations will form the basis for adjustments to the PFI by the system software as a result of PFI management as described below.

In addition to sampling of actual market trades for a particular contract, the system software will establish a canvassing program in which participants will submit their price suggestions, (along with liquidity premiums or discounts for different volumes) via secure electronic communication. The system software will submit a daily schedule of contracts, terms and quantities, and will request pricing information from its covered participants. This information will be compiled along with the Market Sampling data to form the final PFI. During market canvassing, the participants will be asked to submit Liquidity Premiums and discounts (for sale and purchase) of larger volumes of contracts. This Liquidity Factor will then be utilized together with the PFI in calculating the risk transfer conduit system's exposure to a participant resulting from a net position in a particular contract.

(5) The system software verifies delivery of the contracted Commodities through a tracing system which receives data from Sellers and other systems with regard to, transportation, transmission and/or shipping information. In addition the system software verifies payment through a similar tracking system with Buyers, in which information regarding payments is forwarded to the system software. Internally, the system verifies receipt of payments due to the risk transfer conduit system from its electronic marketplace clients.

(6) The system software will continuously monitor the PFI for each contract in which it maintains an exposure, and will monitor information provided by hedge providers to identify and implement hedge positions which will optimize the value of the risk transfer conduit system's risk portfolio.

(7) The system software also controls and provides administrative data to the risk transfer conduit system administrators. The system software provides real-time data to the risk transfer conduit system administrators and the software's administrators related to settlement and clearing of the risk transfer conduit system's standardized contracts. Buyers and Sellers accounts are debited and credited based on the output of the system software settlement and clearing functions.

(8) A sample of the functionality used in connection with the system software is provided. The sample functionality includes a description of the data capture, data provided from the marketing, clearing and settlement services of the risk transfer conduit system and system software, the data provided by the risk transfer conduit system's credit management services, calculations relating to exposures of the risk transfer conduit system to a seller default, calculating exposures to buyer default and calculating net contract exposures of a market participant (including all activities both as a buyer and a seller),

A. Data captured from a variety of different types of market engines, trade matching systems or other aggregation points will include:

1) K_{(Q,t=d-p,place)}=Contract Definition

This includes product definition, quantity, time of delivery and payment (t=d-p), and place of delivery;

2) P_{K}=Price of Contract

3) Participant(s)=Participant(s)

(registered as buyer or seller in contract)

B. Data Provided from virtual market risk transfer conduit system Marketing, Clearing and Settlement Services:

1) PFI_{K}=Price Forward Index

For Contract K, for delivery of Q at time=t, at specified place of delivery;

2) LFₚ=Liquidity Factor Premium (LFₚ)

Indicates the premium over the PFI which would be applied to the purchase of a larger volume of contracts;

3) LF_{d}=Liquidity Factor Discount (LF_{d})

Indicates the discount from the PFI which would be applied to the sale of a larger volume of contracts.

4) P_{K,M,t=d} Market price of the contract at delivery date of contract

C. Data provided by the risk transfer conduit system's credit management services:

1) _{TLparticipant}=Total Limit of Participant Indicating the dynamic view of the virtual market risk transfer conduit system as to the total exposure to a participant that the risk transfer conduit system can accept, based on credit considerations;

2) P_{K,f}=Price Floor of Contract, K

Price floor associated with coverage of payment risk of a particular contract (K_{(Q,t,place)}), to which the coverage is attached. This price P_{K,f} can be either a fixed price or a fixed percentage of the contract price, P_{K}, and represents the minimum price of the contract K which would be used in calculating the risk transfer conduit system's exposure to buyer defaults prior to delivery.

3) P_{K,c}=Price Cap of Contract K

Price Cap associated with coverage of delivery risk of a particular contract (K_{(Q,t,place)}), to which the coverage is attached. This price P_{K,c} can be either a fixed price or a fixed percentage of the contract price, P_{K}, and represents the maximum price of replacing contract K which would be covered by the risk transfer conduit system if a seller fails to deliver.

4) V_{d,tk,p}=Verification Triggers

(d=delivery, tk=take, p=payment)

0—indicates no verification information available for Contract

K

1—indicates delivery, taking or payment is verified

2—indicates non-delivery, non-taking or non-payment is verified.

D. Calculating Exposures to Seller Default. This equates to default by seller in delivery of contracted goods in compliance with the delivery terms in contract. The virtual market risk transfer conduit system calculates maximum possible exposure to seller (E_{s,K,max}) and actual exposure (E_{s,K,act}), related to a contract K, as follows:

1) Requisite information: K_{(Q,t=d-p,place)}, P_{K}, PFI_{K}, P_{K,C}

(where d=delivery date, and p=payment date);

2) Maximum Exposures: Maximum exposure associated with the contract (E_{s,K,max})=(P_{K,c}−P_{K});

3) Actual exposure associated with the contract is:

a) Prior to delivery date (t<d): then

If (PFI_{K}*(1+LFₚ))>P_{K}, then

If (PFI_{K}*(1+LFₚ))>P_{K,c} then:

E_{s,K,act}=(P_{K,c}−P_{K});

Else, E_{s,K,act}=(PFI_{K}*(1+LFₚ)−P_{K});

Else, E_{s,K,act}=0; and

b) At or after delivery date (t=d):

If V_{d}=0 or 2, then

If (PK,M,t=d>PK) then

If (P_{K,M,t=d}>P_{K,c}) then:

E_{s,K,act}=(P_{K,c}−P_{K});

Else, E_{s,K,act}=(P_{K,M,t=d}−P_{K});

Else, E_{s,K,act}=0

Else E_{s,K,act}=0 (ie. when V_{d}=1)

E. Calculating Exposures to Buyer default. This equates to default by the buyer prior to compliance with the payment terms in contract. The risk transfer conduit system calculates the maximum possible exposure to buyer (E_{b,K,max}) and actual usage of exposure (E_{b,K,act}).

1) Requisite information: K_{(Q,t=d-p,place)}, P_{K}, PFI_{K}, P_{K,f} and payment date t=d (where d=delivery date);

2) Maximum Exposures:

Maximum exposure associated with the contract (E_{b,K,max})=(P_{K});

3) Actual exposure associated with the contract is:

a) If 0≦t≦d then

If (PFI_{K}*(1−LF_{d}))<P_{K} then

If (PFI_{K}*(1−LF_{d}))<P_{K,f} then

E_{b,K,act}=(P_{K}−P_{K,f})

Else E_{b,K,act}=(P_{K}−(PFI_{K}* (1−LF_{d})

Else E_{b,K,act}=0

b) If t≧d then

If V_{d}=0 or 1 then;

If Vₜₖ=0 or 1 then;

If Vₚ=0 or 2 then;

E_{b,K,act}=PK;

Else Vₚ=1 and E_{b,K,act}=0;

Else Vₜₖ=2 and

If (PFI_{K}* (1−LF_{d}))<P_{K} then

If (PFI_{K}*(1−LF_{d}))<P_{K,f} then E_{b,K,act}=(P_{K}−P_{K,f}) Else E_{b,K,act}=(P_{K}−(PFI_{K}*(1−LF_{d})

Else E_{b,K,act}=Pₖ

Else V_{d}=2 and;

If Vₜₖ=0 or 1 then;

If Vₚ=0 or 2 then;

E_{b,K,act}=P_{K};

Else Vₚ=1 and E_{b,K,act}=0;

Else Vₜₖ=2 and E_{b,K,act}=0

F. Calculating Net Contract (K) Exposures of a Participant. The total position of a participant to a contract K_{(Q,t,place)} will equal the average long and short positions in any contract;

1) Short Position=Σ₀₋ₙ (number of all contracts Kⁿ_{(Q,t,place)} in which Participant is registered seller)

a) Short Value=Σ₀₋ₙ (Kⁿ*Pⁿ_{K}) of each contract in which participant is registered seller)

b) Average Short Price=Total Short value/Short Position

2) Long Position=Σ₀₋ₙ (number of all contracts Kⁿ_{(Q,t,place)} in which Participant is registered buyer)

a) Long Value=Σ_{0-N} (Kⁿ*Pⁿ_{K}) of each contract in which participant is registered buyer)

b) Average Long Price=Total Long value/Long Position

3) If Long Position>Short Position,

a) Net Long Position=Long Position−Short Position

b) Net Long Contract Value (Net Long Position*Average Long Price)+(Short Position)*(Average Long Price−Average Short Price)

4) And if the Long Position<Short Position,

a) Net Short Position=Short Position−Long Position

b) Net Short Contract Value=(Net Short Position*Average Short Price)+(Long Position)*(Average Short Price−Average Long Price)

As an example of the application of the risk transfer conduit system to a product that is not currently traded as a commodity and for which there is a substantial need for the benefits of commodity market pricing and liquidity, the risk transfer conduit system is applied to the trading of electricity contracts.

In addition to the basic risk transfer conduit system, a logistics optimization system for delivery of the products traded under the risk transfer conduit system was developed to minimize the total costs of shipping or transporting a pool of contracts. This is done, as described below, by evaluating a portfolio of contract trades and then optimizing the delivery costs by pairing up the buyers and sellers, whose identities are not known to each other, in a fashion which reduces the overall shipping costs for all deliveries.

The logistics optimization system can retain the right to reorder delivery of goods among standardized contracts once trading in those contracts has ceased. Because trading in covered standardized contracts is anonymous and the performance risks are covered by the risk transfer conduit system, the virtual market electronic marketplaces are able to utilize a virtual clearinghouse system. The virtual clearinghouse system (VCS) provides a number of unique functions. VCS establishes nominal deliver nodes for each contract covered by the virtual market system. Reference is next made to Fig wherein a graphical example of shipment to a Montreal node for forestry products in accordance with the risk transfer conduit system, but not the logistics optimization system is depicted. VCS calculates a delivery cost to the node (for a Seller) and from the node (for a Buyer). The virtual market system guarantees these delivery costs directly or secures an acceptable third party guarantee. In this way all buyers and sellers are assured a fixed delivery cost to the node and can plan their purchases and sales based on this location.

In accordance with the logistics optimization system, prior to delivery and subsequent to the final trading date of a specific contract, VCS is utilized to reorder delivery of contracts to minimize the total delivery costs associated with all outstanding contracts being delivered. This portfolio approach to optimizing logistics of delivery allows the virtual market system guarantee fixed delivery costs to Sellers and Buyers which are significantly below delivery costs available to a single participant in a one-to-one transaction.

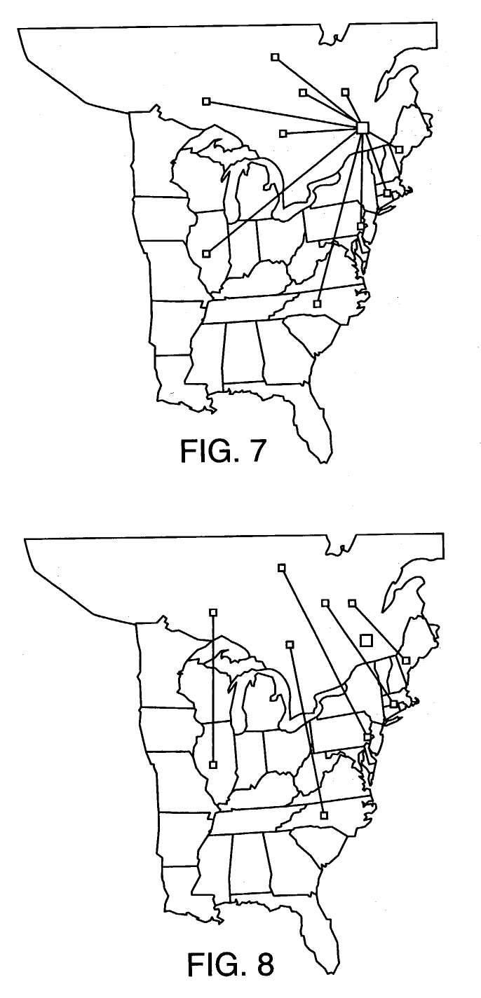

Reference is next made to FIG. 8 wherein an optimized delivery logistics system reduces overall shipping costs. As seen in FIG. 7 there is a pairing sellers and buyer which creates a minimization of delivery cost on a portfolio basis. The effect of this is that the guaranteed shipping cost built into the standardized contract can be reduced from that which would otherwise be required.

In addition, the invention is directed to a receivables funding system developed as an additional ancillary service. The receivables funding system allows sellers of products traded under the risk transfer conduit system to receive immediate payment for the sale of products for delivery at a future date. This is enabled by the financial planning and securitization of the process established by the risk transfer conduit system It is a direct outgrowth of the risk transfer conduit system and the standardized contract system.

Utilizing the receivables funding system, the virtual market system is able to extend the time period for the funding of discounted receivables effectively to the date of sale of a forward contract. The virtual market system can forward funds to any seller participating in the trading of its standardized contracts on the date of sale of such contract, without regard to the identity of the Seller or Buyer or the actual delivery date designated in the forward contract. The virtual market funding conduit system provides a number of unique functions. It provides for excess risk calculations, additional coverage calculations, discount calculations based on virtual market system algorithms and funding of receivables for sellers.

The virtual funding conduit calculates the amount of excess risk (the “Excess Risk”) not covered by the system's Counter-party risk assurance products. This excess risk is the risk that the Pool Cap will be exceeded in any given Predefined Pool of risk.

The virtual funding conduit calculates the costs of obtaining additional insurance of a portion of the excess risks adequate to maintain the system's credit rating. This insurance will be obtained, as required, in the capital, insurance and reinsurance markets as part of the ongoing management of the virtual market system's risk portfolio.

The virtual funding conduit provides quotes of discount rates to Sellers. These rates will be calculated based on algorithms which will take into consideration funding costs based on the virtual market system's credit rating, the term of the forward contract and the all-in costs of additional credit coverage related to the potential funding.

The virtual funding conduit allows Sellers to opt to receive funds for forward sales, discounted at the quoted rate. If a Seller opts to receive such funding, the virtual funding conduit funds through the capital markets (at the virtual market system's rating rather than that of the seller), and obtains additional insurance in an amount commensurate with the Excess Risk associated with the funding amount. In addition, the market participant's risk exposure limit will reflect utilization by the seller of risk coverage for a percentage of the amount of the receivables funded.

In connection with the risk conduit transfer system a key element of standardization is the uniformity of risk among counterparties. The traditional methods of (a) collateral requirements calculated daily for each member of an exchange; and (b) trade credit insurance or letters of credit used in non-exchange trade are (x) costly compared with alternatives unavailable in today's marketplace and/or (y) inadequate, in the case of collateral systems, for many products. A database system that tracks aggregate net exchange-wide risk, (which is much less than the sum of the risk applicable to each participant because of internal netting of risks) so that sophisticated credit insurance and credit derivatives can be used in guaranteeing and insuring counterparty risk across an entire exchange is needed to achieve the desired liquidity. The use of such credit insurance places the insurance provider in the same economic position as each counterparty. As such, the insurance provider can then offer to-the marketplace guaranteed delivery logistics. This is because the insurance provider, because of its economic position, can optimize delivery logistics across the entire pool of marketplace participants, lowering risks and costs. Further, since the insurance provider has guaranteed payment obligations by buyers, it can offer to the sellers unique funding of this obligation. The insurance provider can treat the buyer obligation as a receivable, even through conditions precedent do not exist for the payment obligation. Since the insurance provider guarantees payment and performance of the condition precedent, it can loan to the seller against the future receivable at the contract date.

I. INTRODUCTION

The VMAC product (or the “VMAC System” or merely “VMAC”) will improve the liquidity and reduce the credit risks in the energy trading market at an extremely low cost for trading companies. Implementation of the product will also have a significant positive impact on share values in the sector. The benefits from the implementation of this product will far exceed its costs for participating firms.

This product is of great strategic importance to the energy trading sector. Rating agencies and other important constituencies are extremely focused on the dangers associated with short-term cash-flow for energy trading firms. This is completely consistent with conventional wisdom that the greatest immediate threat to a trading business is loss of access to liquidity. This concern is the reason that regulation of investment banks and trading operations at commercial banks is focused primarily on liquidity.

In the energy markets, inter-trader credit and systemic market integrity are fundamental to liquidity. We have had two examples in recent history of these forces at work. The VMAC product has been developed to address the market's need based on these specific historic experiences.

The VMAC product offers a system of counterparty credit risk transfer designed to replace the risk of counterparty default with a AAA/Aaa financial guarantee. In the current market, counterparty credit risk is either taken on the books of a trader or managed through onerous collateral calls and expensive and inefficient credit derivatives. With the VMAC product, rather than relying on counterparty credit, collateral posted by counterparties or on a credit derivative, market participants will rely on a AAA/Aaa financial instrument. The guarantee is a financial market structure, accepted widely as an effective and liquid replacement of credit risk, superior to a pledge of collateral, providing assurance of prompt payment upon default of a counter-party, without conditions or deductibles. The VMAC product will provide assurance to market participants, and to the sector's shareholders and lender as well, that the energy markets will remain stable and credible even through the periodic volatility that has been its history.

Why use a central insurance provider? By using a single, central financial guarantor for multiple market participants, the total net credit associated with the trading activity of each market participant is reduced to a fraction of the credit previously involved in trading. With less credit used, cost is minimized. The VMAC product is far more cost effective as a risk transfer device than any bilateral mechanism, reducing aggregate market credit risk through a netting process before transfer to the financial markets.

In most commodity and derivative trading markets, a similar function is provided by a central clearing house. This is an inefficient mechanism for domestic energy trading and cannot meet the industry's needs. The VMAC product is designed to provide all of the benefits of the clearing house structure, but in a way that is practical for the US energy markets.

The first premise behind the VMAC product is there are only two ways to address the credit issue in the United States energy markets in a way that satisfies the rating agencies, equity analysts and shareholders of trading firms: (a) bilateral solutions that are impossibly expensive or (b) less-costly multilateral solutions of the type used for other large scale commodity trading operations. The second premise behind the VMAC product is that the traditional multilateral techniques are impractical, because of the very nature of the energy markets.

After the events of the autumn of 2001, VMAC believes even more firmly that these premises are true. The positions taken by rating agencies and stock analysts (as well as the damage to share values) in wake of the Enron debacle tells us clearly that bilateral solutions are too weak and lack transparency. Simply shoring-up these bilateral approaches would be extremely expensive. Satisfying the emerging standards set by rating agencies will likely threaten the market in its current form.

Why is a multilateral approach so important? In order to credibly establish a market that the credit rating agencies, equity analysts, lenders and shareholders believe is stable and reliable, protection from an identifiable amount of risk must be secured. It is estimated that the VMAC System of multilateral netting can reduce the amount of risk that must be covered by as much as 80%. This results in an enormous reduction of cost and, perhaps even more importantly, relief from the unpredictable and dangerous short-term cash flow demands of the trading business. Thus a cheaper, multilateral approach is called for.

Why not use the conventional multilateral approach for commodities markets, that is a central clearing house? Especially in the US, electricity and natural gas are fundamentally different from the classically defined commodity which is a good that is fungible, storable and readily replaceable to cover a contract position. These are precisely the characteristics that form the theoretical basis for clearing houses. Market integrity requires that defaulted positions must be covered quickly at predictable cost. In particular, electricity, a non-storable product whose value is dependent on specific time and place of delivery, could not be more different. Therefore, a new type of multilateral solution is needed.

This new solution includes:

A system which developed based on input from rating agencies and other market observers, which will be critical to achieving the optimal result in terms of investor perception for the implementation of any system.

Credit insurance in sufficiently large size to support the VMAC product A facility in amounts well in excess of $1 billion is sufficient to support approximately $30-50 billion in trading.

The software system necessary to capture trade data from electronic exchanges, from voice brokers and from back offices of VMAC product participants in place and ready to be connected to multiple trade matching environments.

The risk algorithms and netting calculations described herein and tied into the database described above. Thus, the VMAC product is able to (1) calculate the trade-by-trade risk using mathematical approaches consistent with industry practices, (2) pool these risks in a multilateral portfolio, and (3) calculate the netted risk associated with the portfolio. Table 1., set forth below, illustrates that the cost of the VMAC system (based on a volume discount) is offset by savings associated with netting and the avoidance of credit risk.

TABLE 1
Cost Analysis of VMAC System
($100,000 Electricity Trade)

| | Intermediate | | Short | |
|---|---|---|---|---|
| | Duration | | Duration | |
| | (105 Days) | | (30 Days) | |
| Cost of Bilateral Trade (1) | $ | 44.60 | $ | 31.90 |
| Cost of VMAC Trade | | | | |
| Fee | | (25.00) | | (20.00) |
| Collateral/Exposure (2) | | (8.90) | | (6.40) |
| Direct Savings | $ | 10.70 | $ | 5.50 |
| Other Savings | | | | |
| Reduction in Counterparty Credit Expo- | | 12.10 | | 8.00 |
| sure (3) | | | | |
| Administrative/Back Office (4) | | 25.00 | | 25.00 |
| Total Savings | $ | 47.80 | $ | 38.50 |
| (1) Key Assumptions: | Intermediate | | Short | |
| Average Bilateral Exposure per Trade | $ | 18,000 | $ | 45,000 |
| (Mark-to-Market + VAR) | | | | |
| Cost of Exposure (per annum) | | 0.85% | | 0.85% |

(2) Assumes an 80% reduction of collateral/exposure based on netting
algorithms.
(3) Average collateral/exposure times 20% times (counterparty's credit
spread minus 15 basis points). The 20% is a reasonable estimate of the
imbedded credit exposure in a trade that is collateralized with a low
investment grade counterparty; the 15 basis points is an assumed credit
spread for a AAA/Aaa rated corporation. This is intended to measure the
superiority of a financial obligation of FSA over a collateral account
for the same exposure to a defaulting party.
(4) Based on conversations with market participants.

Not shown in this analysis is:

increased shareholder value and lower capital cost through a safer, more transparent system; we believe that this value far exceeds the fees for the product

potential benefits of incorporating an integrated settlement service at a future date

IV. Market Analysis

Energy trading has grown rapidly in the past few years to become an enormous marketplace, representing as much as $1 trillion of trading volume per annum. The market is unusual in a number of respects that directly impact the perception of the participants among various financial, governmental and media players who are quite important to the continued profitability of these participants and ultimately to shareholder value.

Regulation. The wholesale trading markets are subject to minimal direct and indirect regulation by government authorities. By this we mean that the markets themselves are largely exempt from CFTC oversight and regulation under the Commodity Exchange Act. In addition, the participants, unlike commercial and investment banks, are not regulated as to capital adequacy, liquidity and other factors by virtue of their participation in other markets that generally impact on systemic market risk.

While this is troubling to some observers of the business, it is a status that most participants would like to maintain. The healthiest form of regulation is in the form of market discipline. Today, the financial markets are telling the energy traders that the risk of the trading markets is both greater than it should be and less transparent to the analytical community (rating agencies and stock and bond analysts) than this community would like.

The best way to limit the potential for formal regulation is for the industry to provide the risk management systems and transparency that the markets see as consistent with a stable industry. Specifically, a systemic, industry-generated approach to managing credit risks inherent in trading that the financial analysis community understands and can use as a window into the credit risk of trading would be a boost to investor confidence.

Underlying Traded Products. The issues of the trading markets must be addressed based on a thorough understanding of the underlying products. These issues are best understood in the context of traded physical electricity contracts. This constitutes the core issue to be addressed in the emergence of liquid, efficiently priced trading markets for energy.

Electricity has a number of unusual characteristics, when compared with commodities that are more commonly traded:

Its value is time and place specific.

It cannot be stored effectively.

Governments generally impose severe limits on retail market forces, such as obligations to provide service, price regulation and general political interest in the price of electricity.

Electricity consists of constituent commodities—i.e., fuel, generation capacity, transmission capacity, and emissions limitations—that behave very differently in terms of price.

These factors have a number of implications with respect to the systemic management of counterparty credit risk. Systemic commodity market credit risk is generally dealt with through the efficiency of an exchange or other matching platform and the integrated operation of a clearing house. The application is, of course, focused on the clearing house function.

To date, credit clearing has been imbedded in the operations of individual market participants. Enron was one of the prime examples of a marketer evolving into a matching platform (performing the exchange function) and a clearing house (using its balance sheet as the credit intermediary). However, Enron went even further, extracting credit derivatives from the matched trade by extending and receiving credit in the process. To a greater or lesser extent, this has been a practice in the marketplace that observers now understand and generally find troubling.

Traditional clearing houses typically address risk in three ways. First, and by far the least important, is evaluation of the credits of the participants. Generally, clearing houses base their operations on the assumption that collateral and other funds must protect fully against any default, thereby minimizing the materiality of underlying credits. As a result, their participant credit scoring and monitoring procedures are minimal.

The second, and more important, level of risk management used by clearing houses is to measure periodically the risk of each position and take collateral against this risk. This measurement takes the form of marking contracts to market and calling collateral, to the extent needed to cover this risk.

The third way of addressing risk is to measure statistically the probability that the mark to market collateral will be inadequate in the real world event of a default. The elements of measuring such risk include an analysis of statistically worst-case market volatility over the periods of exposure. One period of exposure is the gap between marks to market. The other period is the time required, in a statistically worst case scenario, to hedge or liquidate the position of a defaulted party. The first period has to do with the systems set up to mark to market; the second is dependent primarily on liquidity in the marketplace as demonstrated by historic performance, with a view to effects on the market likely to be correlated with a participant default.

Energy trading presents several fundamental problems inhibiting the use of the traditional clearing approach:

Because of the multiple and disparate markets, continuous quotes from market makers cannot be relied upon to establish a price for marks. Therefore, an interpolated index is required to measure risk in positions at a point in time.

The imbedded elements of electricity, in particular, such as transmission and generation capacity and price inelasticity at the retail level, produce substantial volatility on the margins. Prices tend to increase rapidly and decrease just as rapidly (for example when the demand/capacity relationship becomes imbalanced and then normalizes). Especially for shorter duration contracts, potential volatility during the “gaps” described above can be extraordinary.

In a fragmented market in which governmental intervention is always possible, liquidity is a significant problem. This means that a potential “gap” constituting the period required to hedge or liquidate a position of a defaulting party is relatively uncertain.

As a result, unlike commodities, such as metals or oil, stocks and debt instruments and financial derivatives, the math that underpins traditional risk mitigation in commodities markets must be applied in new ways to address the US energy markets.

The mark to market and liquidity/volatility concepts which are used by clearing houses for liquid commodities and related derivatives are fundamentally related to the concepts used in-house at most energy trading firms to measure risk. Thus, the same issues must be addressed whether a system is a single trader's or is one used by a group of traders. The shared system is less problematic, of course, because the statistical base is broader.

History

The energy trading markets have a history that is a concern to the financial analyst community and to potential regulators. The events of the summer of 1998 first pointed out the problems of volatility, liquidity and credit. Yet these events were relatively isolated.

California (during 2001) is a different story. Industry observers understand that the underlying facts were unique. However they believe that there are many lessons of general applicability to be learned from the episode. First, demand/capacity imbalance is a continuing potential issue in partially deregulated markets. Also, government intervention is always a possibility when dealing with vital commodities such as electricity and natural gas.

There are important systemic lessons for the trading market as well. Liquidity is a continuing problem. For many reasons, positions may not be readily hedged or liquidated in this market. A regional capacity shortage problem cannot be addressed by adding capacity located somewhere else. A contract involving gold or shares of (for example) General Electric Corporation can be hedged anywhere in the world at any time; not so electricity or natural gas. Traders and central risk systems must take these factors into consideration when involved with these commodities.

The state sponsored electricity exchange in California (the “CalPX”) sought to address this by spreading the credit risk throughout the industry via a thinly capitalized clearing house that had rights to mutualize risk among participants. In theory, this can be a good mitigation tool. In practice, however, there are many pitfalls. The factors set forth above regarding the energy markets leads to some inescapable conclusions.

First, problems can grow to a large size rapidly. There is likely to be a lot at stake for those who receive a mutualization call.

Second, because the market is fragmented and discontinuous, risk mitigation involves many decisions and judgment calls. If a clearing house is dealing with contracts for shares or metals, it will hedge or liquidate as quickly as possible. If energy is the underlying product, hedging and liquidating can be very complicated and much judgment must be exercised.

In addition, some form of governmental or judicial interference may be expected.

With all of these moving parts, there are many opportunities for parties to seek to avoid mutualization, including through governmental or judicial intervention.

Enron constitutes a third lesson that is still firmly in the minds of the industry and investors. While many problems of Enron originated away from energy trading, the immediate cause of the Enron failure was a short-term cash shortage resulting from the liquidity demands of energy trading. Enron's other problems caused a loss of confidence that in turn caused a cash crunch. Enron had constituted itself as a captive marketplace, with the explicit intent of using market power and information to profit disproportionately. When Enron lost available credit to back its trading, that marketplace evaporated. Therefore, the episode had many attributes of a systemic market meltdown, as if an exchange clearing house had failed, and is an illustration to financial analysts and regulators of systemic market risk. Fortunately, it happened at a time of relatively low price volatility in the market and there was an alternative trading platform. However, the damage was severe enough and observers could extrapolate the potential economic damage if the environment had been different.

V. Solutions

There are two approaches to the problem of credit risk in the marketplace. One involves steps to be taken at the individual trading houses to shore-up credit procedures supporting bilateral trading. The other involves a multilateral centralized approach. The following table (next page) summarizes these approaches and includes an analysis of the viability of each approach.

TABLE 2
Energy Market Credit Options

| Approach | Solutions | Issues | Comment |
|---|---|---|---|
| Bilateral | Status quo, | More collat- | Extremely expensive; |
| | with retrofits | eral and uniform | bilateral netting re- |
| | | procedures and | sults in greater col- |
| | | risk measurement | lateral requirement |
| | | required by rating | |
| | | agencies and inves- | |
| | | tors | |
| Multilateral | Established | Large and novel | Regulators, rating |
| | clearing | incremental risk to | agencies and existing |
| | house | clearing house | clearing house mem- |
| | | balance sheet | bers will resist this |
| | | | large, new and diffi- |
| | | | cult to measure risk |
| | New clearing | Equity capital re- | Mutualization is ill- |
| | house | serves for a | suited to energy |
| | | credible clearing | markets; Rating |
| | | house will be im- | agencies and investors |
| | | practically large; | will resist as a solu- |
| | | mutualization of | tion |
| | | risk must be the | |
| | | primary risk | |
| | | transfer vehicle | |
| | VMAC | Same netting ad- | Views of all interested |
| | credit en- | vantage as clearing | parties accommodated |
| | hancement | house; tailored to | |
| | | energy markets | |

Bilateral Approaches. Reliance on the bilateral approach in the current environment suggests significant changes in the procedures at individual trading houses. Fundamentally, the bilateral approach currently used suffers from non-uniformity as measures of risk differ among traders. Financial analysts and regulators do not like this.

They also find that the practice of extending credit between trading counterparties is problematic. Trading firms are not capitalized like banks and are not subject to that type of regulatory scrutiny. The integrity of such a large and important market is important and analysts and regulators are already reacting negatively to the concept of continued exposure to the credit intermediation activities of the traders.

Furthermore, the practice of energy trading firms extending credit to one another without cost is a major market flaw and clouds the reliability of reported earnings. The price of credit should be differentiated to reflect the true cost of operations. With multiple, undisclosed and unpriced credit lines there is simply no market discipline. Bilateral credit limits are considered by market observers to be unreliable and blunt instruments of market control.

In short, approaches that improve credit systems in a bilateral context are very expensive.

Multilateral Approaches. We believe that the practical way to address these issues is multilaterally. There are two essential elements to a multilateral approach:

1. The approach should incorporate substantial multilateral netting of credit positions against each other. This will sharply reduce the cost of addressing the credit issue, as described in some detail below.

2. Material credit risk should be either transferred to the broad financial markets or mitigated operationally by market participants. This means that pure financial credit risks should not be absorbed by market participants, but rather by financial institutions that syndicate and manage these risks in a portfolio. Credit exposures that remain with a participant (referred to as “tail risk”) should be only those which cannot be transferred readily. Generally, “tail risk” in these markets can best be mitigated operationally. Mutualization of the “tail” risk should be employed, if at all, only after most risk is otherwise addressed and if the conditions precedent are clear.

As we have discussed, there are three approaches to a multilateral solution.

Traditional Clearing House. One of the existing clearing houses could step in as a counterparty to each side of each trade. The credit behind the trade would be the balance sheet of the clearing house.

Clearing house balance sheets are typically made up of default reserve funds that are funded from member contributions. In prior years, risks in excess of default funds were typically mutualized among members through assessment rights for deficiencies. All significant clearing houses were de-mutualized in the last few years.

Clearing of physical electricity and gas would be an extraordinary large incremental risk for an existing clearing house. Their regulators and clearing members generally require the clearing house to provide a AAA level credit to assure market integrity. It is not clear that there is any amount of additional default fund capital that would permit a clearing house to clear energy trades on balance sheet and preserve this credit level. Both the regulators and the members (whose deposits would be exposed to the energy market risk) would have a major concern if this risk were taken on.

Based on research and market analysis, we believe that it is highly unlikely that any of the major clearing houses in operation today could practically clear physical energy trades in the US market using their balance sheet.

Special Purpose Clearing House. Another approach is to create a special purpose clearing house that has loss reserves and mutualizes losses above reserves. It is undoubtedly the case that the reserves will be substantially less than the amount required to cover the risk of loss at a reasonable level of statistical certainty. Thus the mutualization aspect of the special purpose clearing house will be central to its reliability.

It might be enough to say in respect of a special purpose clearing house that leaving the quantum of risk that the existing clearing houses deem too large with the industry is reason for concern. However, we believe that this approach is probably even worse than the current bilateral system in respect of risk transfer and market reliability.

The ultimate mutualized risk is really a re-transfer of risk back to the marketplace. Special purpose clearing houses measure this risk using means developed for commodities and derivatives, known as SPAN. The conventional means for calculating risk in commodities markets is not appropriate for power. This is because an option on generating capacity and an option on transmission capacity are both imbedded in power prices. These options are normally out of the money, but are tremendously leveraged so that they are very volatile when in the money. This is not at issue with commodities and derivatives.

Using historical power prices to predict statistically the market loss in the event of a default must incorporate the calculation of the volatility of these options to be accurate. This has a number of impacts on the viability and credibility of any clearing house solution. Basically, if a party has no capacity to hedge this option with physical assets, its expected loss is difficult to calculate, but in any event enormously large. We believe that by transferring this risk to a financial intermediary, i.e., a mutualized special purpose clearing house, the risk to members is even greater than it is in the current system. At least in the current market environment, participants are well equipped to hedge or mitigate by taking actions in the physical marketplace (e.g., arranging alternate transmission routes or wheeling from a more remote generating asset). A clearing house has no capability in this regard and is left to suffer whatever financial loss results. (Our observation is another aspect of the market characteristics that have frustrated the development of electricity futures that could hedge physical contracts.)

We believe that the special-purpose clearing house is inadvertently designed to create larger losses than the current system because of the inability to hedge or mitigate. Even larger losses could be envisioned if the intermediary fails and damages liquidity in the market at a time of stress. We believe that this type of system would be at significant risk of systemic failure, creating widespread illiquidity and credit stresses.

Given the level of risk a special purpose clearing house faces, there is a potential for resistance of the mutualization call. Energy being complex and the market being illiquid, there could be base for complaint regarding risk mitigation. This could come from creditors of the defaulting party as well as from participants receiving a funding call. The concern is that a call could be resisted directly or through a bankruptcy court. This issue is particularly acute for market observers given the CalPX experience.

Structured Product. The other approach is the VMAC system's. The VMAC system is structured to extract the physical risk from the credit system. It leaves the physical risk with the trading entities that trade power in the regions in question and are best equipped to solve the physical problem and to mitigate it. They are far better able to hedge the risk or mitigate un-hedged risk than a thinly capitalized, single purpose financial intermediary like a power clearing house would be.

The VMAC system is one in which the entity providing the clearing function is not in fact a traditional clearing house, but rather is a transaction credit enhancer. As a result, a catastrophic default would not bring down the entire clearing system through a default of the central counterparty of one (or more) trading entity's as might occur in traditional clearing structures.

In the VMAC system, each transaction would be credit enhanced up to a level that would make a loss in excess of the enhancement a remote event. The transaction would be measured on a mark-to-index basis, at least on a daily basis and that amount would be covered by AAA credit insurance. Additional coverage would be provided to each transaction in the form of “Liquidity Coverage.” This would be an amount based on calculations as to liquidity (the time needed to cover off the position) and volatility. Both of these factors would be determined from historic data and the views of the participants as to adequacy. We would expect that buy-in from the financial analysis community would be an important factor as well.

This is a very efficient way to proceed. As discussed below, the actual amount of credit enhancement required is a fraction of the sum of the coverages because the VMAC system allows for extensive netting of these coverages. Without requiring a central counterparty that takes on the entire risk of the marketplace, the VMAC product is able to offer netting that is just as powerful as that available in a traditional clearing house. We believe that it is the only practical method to efficiently and affordably address the systemic risk that is plaguing the industry sector.

In order to avoid the systemic problems of acting as a direct counterparty, the VMAC product will not insure the “tail risk”, that is, the risk of loss in excess of insurance coverage on a trade. This issue should be addressed so as to create a credit risk market place, given the physical realities of the market.

If the market wishes to spread the tail risk, a physical market approach rather than clearing house mutualization can be used. The following are the steps included in this approach.

The defaulting participant's counterparty (“Participant A”) would receive the Mark to Index and Liquidity Coverage payments as described below.

Participant A could elect to keep those payments and cover the physical position in the context of its ongoing business. This would be a good choice if the default resulted from a financial failure of the participant and the demand/capacity balance in the marketplace remained stable. Thus, Participant A could readily replace the lost capacity or demand.

Participant A would also have the option to invoke a Mitigation Procedure that the other VMAC system participants would have agreed to. It would likely use this option if the defaulted contract were difficult to replace because of a capacity constraint due to increased demand, lack of available generating or transmission capacity or a similar situation.

If Participant A invokes the Mitigation Procedure, the VMAC system will hold a Dutch auction immediately among all VMAC system participants to replace the defaulting counterparty's position at a price of Mark to Index plus an upfront payment by Participant A equal to the Liquidity Coverage. The auction will be held over the course of a few hours.

If there is no bidder, Participant A will have the right to put or call power, as appropriate, “Pro Rata” (as defined below) as per the defaulted contract at the Mark to Index Price to each of the VMAC system participants, including itself. The put/call will require an upfront payment to each Participant equal to Pro Rata Liquidity Coverage.

“Pro Rata” means the percentage based on each Participant's VMAC system trading volume at or within the appropriate delivery hub over the preceding six months.

This procedure is a far more effective) way of distributing the “pain” of a default. It avoids the problems illustrated by CalPX's clearing apparatus. It does not leave the physical market risk with a financial intermediary who lacks the physical capacity to deal with it. It also eliminates the problem of a mutualization call for capital that is simply not credible given the nature of the risks and the ability to contest payment.

VI. The VMAC Product

The VMAC system operates a counterparty credit insurance system designed to transfer efficiently counterparty credit risk from the books of trading firms to the financial markets. Details of the operations are set forth below.

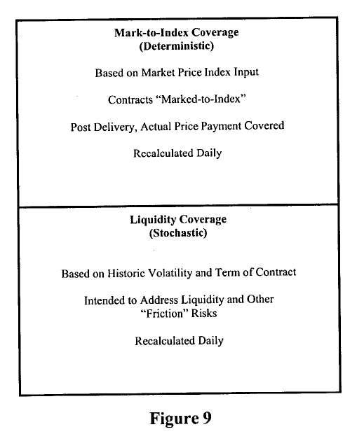

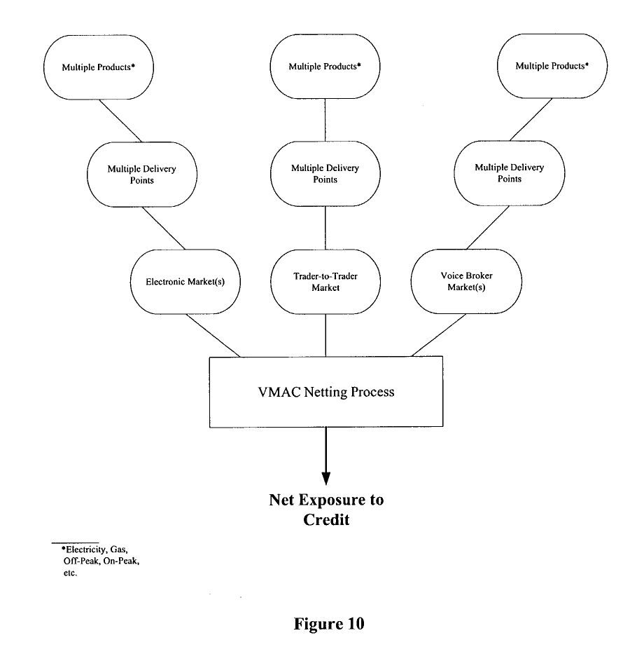

Elements of Coverage. The VMAC product performance obligation coverage is composed of two elements. A market-based coverage designed to cover losses as of the time of default and liquidity adjustments designed to cover losses experienced while positions are covered (see FIG. 9).

A. Market Based Coverage

The VMAC product's market based coverage is calculated for buyers as the difference between the VMAC Market Index (as defined below) and the contract price. For seller's exposure to buyer default, coverage is calculated initially as the difference between the contract price and the Market Index; and after delivery the seller is covered for 100% of the contract price.

B. Liquidity Coverage for Physical Contracts

The VMAC product also provides coverage to both buyers and sellers in physical contracts of market losses incurred in replacing a contract in an illiquid marketplace. The coverage amount is related to the Value-at-Risk (VAR) associated with a position in a contract at the current market price. This amount is designed to reflect liquidity and volatility factors and will take into account market price (as indicated by the market index), duration of the contract and other delivery terms of the contract.

On a daily basis, the VMAC system calculates the Mark-to-Index and, based on that Mark-to-Index, the Liquidity Coverage for each contract. The maximum payable amounts for all contracts held in a participant's portfolio are then netted to determine the actual total coverage required to support a participant's trading portfolio. Using proprietary the VMAC product structures, the VMAC product is able to net coverage of contracts across both product types and market platforms as illustrated in FIG. 10.

Mark-to-Index Coverage. The Mark-to-Index Coverage of a contract insures that an in-the-money market participant will be paid the Mark-to-Index calculation on each of its in-the-money trades in the event of a counterparty default. Under the VMAC system all contracts of a defaulting party, including those in which the defaulting party is in-the-money, will be liquidated at the Mark-to-Index value. Therefore, the in-the-money positions of one party may be covered, in whole or in part, by out-of-the money positions of another party, with the VMAC system acting as the central counterparty for credit risk. Because the VMAC system is allowed to liquidate in-the-money contracts held by a defaulting party in order to access the Mark-to-Index value to cover liabilities in respect of the defaulting party, VMAC system coverage is netted across both product types (e.g., same commodity at different delivery times and places or different commodities) and market platforms (e.g., exchanges).

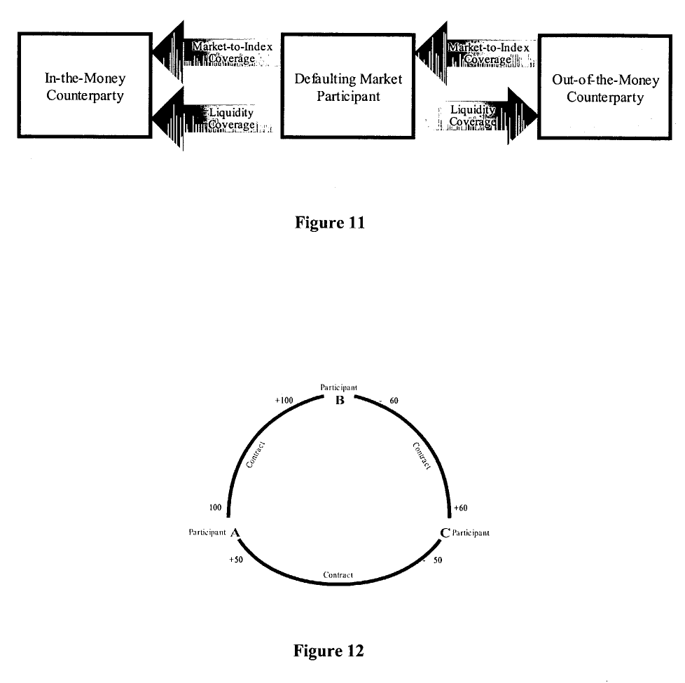

VMAC Liquidity Coverage. In addition to the net Mark-to-Index Coverage described above, the VMAC product provides additional coverage to each contract party. This coverage is particularly focused on the problems involved with physical delivery contracts related to replacement of the contract in markets with limited liquidity. FIG. 11 outlines how the Liquidity Coverage flows to a participant. The VMAC system calculates the net exposure to the portfolio of counterparties based on the potential payout (in the case of an in-the-money contract) or crediting (in the case of an out-of-the-money contract) of Liquidity Coverage amounts. It should be noted that in the event of a default by a participant, VMAC will require the liquidation of all contracts with the defaulting party. VMAC will pay to an in-the-money counterparty the maximum of i) replacement cost of contract, or ii) the sum of the mark-to-index plus the Liquidity Coverage. VMAC will require payment from an out-of-the-money counterparty of the lesser of i) the actual market replacement value or ii) the mark-to-index less the Liquidity Coverage.

The amount of Liquidity Coverage is based on calculations completed daily by the VMAC system and provided to market participants. The algorithms are designed to meet the needs of the marketplace. The VMAC system takes into account the following elements for each delivery hub (with adjustments for price correlated delivery points):

The current Mark-to-Index Price

Duration of the contract

Historic Volatility

Historic Liquidity

Historic mean price reversion

These factors and others have been used by Risk Capital Management to generate algorithms, on behalf of VMAC, for Liquidity Coverage for the VMAC database analytics. Preferences different from these based on Core Group requirements can be accommodated.

The amount of Liquidity Coverage applicable at any given time to a specific contract will be comparable to the “Value at Risk” calculation performed by many market participants routinely. The actual insurance for Liquidity Coverage applicable to a contract will be no more than the larger of the Liquidity Coverages calculations applicable to the two counterparties, since only one party can go into default at a time. The insurance amount is further netted for price correlated contracts, as described below.

VMAC Contract Liquidation Rules. In a traditional exchange for liquid commodities, a clearing corporation acts as counterparty for a trade and maintains market rules for the treatment of collateral and contract positions if a party defaults. Similarly, VMAC has rules that govern the application of its product to bilateral trades for illiquid commodities. These rules are designed to allow VMAC to provide credit insurance on a net exposure basis, thereby capturing the benefits of such netting for the participants. A listing of the basic VMAC Rules of Coverage is listed in Table 3.

TABLE 3
Basic VMAC Coverage Rules

| | |
|---|---|
| 1. | “Standby Amount” is the maximum coverage arranged by a partici- |
| | pant and available to support its' trading. |
| 2. | “Net Exposure Amount” is the total net exposure to a participant |
| | based on all VMAC covered trades with that participant. |
| 3. | “VMAC Uncollateralized Credit Limit” is the maximum net exposure |
| | which VMAC will allow to a trading participant without the posting |
| | of collateral. |
| 4. | “Collateral Amount” is the amount of collateral posted by a partici- |
| | pant in order to allow its Net Exposure to exceed the VMAC Uncol- |
| | lateralized Credit Limit”. |
| 5. | “Default Event” includes failed performance on a contract, bank- |
| | ruptcy and failure to post collateral when Standby Amount is ex- |
| | ceeded. |
| 6. | “Default Amount” with respect to any contract is defined as the lesser |
| | of (a) the actual market loss and (b) the sum of the Liquidity Cover- |
| | age and the Market Price Coverage as of the date immediately pre- |
| | ceding the date of default. |
| 7. | If a Default Event occurs, VMAC can replace the defaulting party or |
| | pay the counterparty the Default Amount, (except that on and after |
| | the time of performance, VMAC will make full payment of the De- |
| | fault Amount). |
| 8. | If a Default Event occurs with respect to a party, and the net Mark-to- |
| | Index position of one of its counterparties increases as a result to an |
| | amount that would cause the Standby Amount to be exceeded, |
| | VMAC may require the counterparty to post collateral immediately to |
| | eliminate such excess. |
| 9. | If a Default Event occurs with respect to a party, and such party |
| | holds a contract which has been Marked-to-Index in its favor, VMAC |
| | can require the counterparty to liquidate its position and pay the |
| | Market Price Coverage (net of a VMAC Liquidity Coverage adjust- |
| | ment) amount into trust to secure the defaulting party's obligations. |
| 10. | After Mark-to-Index payments are made upon a default by a Partici- |
| | pant, VMAC may substitute parties to contracts for identical |
| | products and re-price the novated contract at the Mark-to-Index |
| | price. |
| 11. | Upon a default by a Participant holding long and short positions in |
| | price correlated products, Seller delivers to Buyer's delivery point |
| | at Buyer's Mark-to-Index price; Seller is paid “Net Net” Liquidity |
| | Coverage for both Contracts. |
| 12. | “Net Net” Liquidity Coverage for price correlated contracts equals |
| | (1-Correlation Factor) times (Net Liquidity Coverages in netted |
| | Seller and Buyer Contracts). |

The basic VMAC coverage rules are designed to allow the system to function on a netted basis, whereby the net coverage is made available to the system through a liquidation of all contracts held by a defaulting party.

VMAC Estimated Costs. The total cost of the VMAC system is far less than the apparent and imbedded credit costs associated with existing bilateral trading systems and the comparable protection afforded by the credit derivatives markets. The total cost is comprised of the cost of Liquidity Coverage plus the cost of the Mark-to-Index Coverage for out-of-the-money trades plus the cost associated with any receivables financing to the parties. Participants will also benefit from the anonymous trading afforded by the VMAC system and the liquidity VMAC will provide to the marketplace.

Indexes. In order to calculate the Mark-to-Index and Liquidity Coverage payable in the event of default, a series of Market Indices will be required. Any credit system, bilateral or multilateral, requires an agreed index to measure credit. A multilateral system requires that at least three parties must agree on the index. VMAC can function just as well regardless of the index so long as participants agree on it. VMAC will assist the market on implementing an index, but has no preference for any index or any particular rule Subject to market requirements, the VMAC system will generate several forward curve Indices based on correlations to the following delivery points:

| Electricity | Natural Gas |
|---|---|
| 1. Cinergy | 1. Henry Hub |
| 2. COB | 2. NW Rockies |
| 3. Entergy | 3. Southern California Border |
| 4. Palo Verde | 4. TCO |
| 5. PJM | 5. Transco Zone 3 |
| 6. NEPool | 6. Transco Zone 6 |
| | 7. Chicago City Gate |

The Market Indices will be compiled and calculated in the following manner.

Data Compilation. The VMAC system will obtain data as to contract type, price volume, duration and delivery points from multiple sources. Those sources should include:

Electronic Exchanges (Trade Data)

Voice Brokers (Forward Curves and Trade Data)

VMAC Participants (Forward Curves)

Other published indices

These estimates will be encrypted to maintain the confidentiality of sources.

The VMAC system will assemble the trade data and the participant forward curves and apply algorithms designed to weight the data and produce a set of indices. The algorithms will be published by the VMAC system on a website.

Data Fill. To the extent that the forward curve Market Indices compiled and calculated as set forth above are incomplete, VMAC will poll the Core Group to provide estimates necessary to fill the gap. With this data fill, the forward curve Market Indices will be complete.

Publications. The Forward Curve Indices will be published each day on the VMAC website. Mark-to-Index and Liquidity insurance coverage will be calculated based on these Market Indices.

Credit Coverage. As discussed, the VMAC system offers participants coverage of credit exposure related to bilateral contracting for power and gas contracts. The AAA rated coverage includes a guarantee of the Market-to-Index value of the contracts by marking the contract to the Market Indices. In addition, the coverage includes Liquidity Coverage, which take into account volatility and duration of the contract; as the duration of a contract shortens, the VMAC Liquidity Coverage increases to cover the increased volatility.

Credit Usage. VMAC charges for the coverage of a participant's risk to its counterparties by measuring the net Mark-to-Index and Liquidity Coverage associated with that participant's portfolio. Therefore, if a participant is out-of-the-money $10 on a net Mark-to-Index basis and has net Liquidity Coverage exposure to its counterparties of $3, the total coverage usage charged to the participant is $13.

VMAC Credit Limit. The VMAC system offers each participant a VMAC unsecured Credit Limit determined by examining the credit rating of the participant (or if a parent indemnity is provided, the rating of the parent). The participant may then enter into VMAC system covered trades without posting collateral, as long as the total unsecured Credit Usage remains below the VMAC unsecured Credit Limit.

Standby Amount A participant must designate the amount of maximum VMAC unsecured credit it anticipates using. This allows VMAC to fix the potential costs of Credit Usage at discrete points in time. A standby fee must be charged on this amount to cover the capital set-aside requirements of the credit insurers. A participant may elect to designate a Standby Amount below the total available VMAC Credit Limit.

Collateral Posting for Credit Usage Above VMAC Credit Limit A participant may elect to enter into trades which create net Credit Usage measures above the total VMAC Credit Limit. In this case, the participant simply posts collateral in the amount it wishes to exceed the VMAC Credit Limit.

Credit Screening. VMAC will receive trade data constantly from a variety of sources: electronic exchanges, voice brokers and back offices in trader-to-trader transactions. VMAC will accept for insurance each trade so long as the amount of Liquidity Coverage applicable at the time the trade is entered into does not exceed the trader's available credit limit, including collateral posted and not yet used to support trading. If such amount is exceeded, the trade will not be accepted for insurance.

It is expected that the refusal of a trade will be extremely rare. Each trader will have the calculations of available credit and Liquidity Coverages readily available. The VMAC system will transmit these amounts at each re-calculation cycle. Errors will typically be corrected through telephone calls. It is not in the VMAC system's interest to cause trades to be undone.

This credit securing system is used by all of the major clearing houses. The real world experience is that virtually all problems are errors that get corrected in the ordinary course of daily activity.

VII. Netting

As discussed above, there are two elements of the measurement of credit risk in any commodity transaction:

The amount of risk measured at a specific point in time defined by the cost to replace the contract in the market. This “Mark-to-Market Risk” uses either actual prices in a marketplace as a measurement or, where such prices are not available, an index of prices that serves as a surrogate. Either actual prices or a surrogate are required to measure risk instantaneously.

The potential for increase in the risk between the time it is measured and (i) the next time it is measured, if there is no intervening default, or (ii) the point at which the position is hedged or liquidated, if there is a default. This potential, referred to as “Liquidity Risk” is theoretically limitless. However, statistics based on historic data and analysis of physical market characteristics are commonly used to measure an amount to some level of confidence (i.e., three standard deviations).

A traditional clearing system allows the clearing house to net contracts against each other as collateral. This allows the positive and negative Mark-to-Market Risk positions of a trader to be off-set against each other. The net is then collateralized at each time of measurement.

Liquidity Risk is covered in a clearing house by a combination of initial collateral deposited by a participant and money deposited into default funds by a participant, each provided as a condition precedent to participation. The Mark-to-Market Risk netting assumes a “perfectly efficient” marketplace; the funds covering Liquidity Risk are in place to keep the clearing house whole because no market is “perfectly efficient.”

Electricity markets, in particular, are very far from perfectly efficient, as discussed above. Therefore Mark-to-Market Risk netting through a traditional clearing house would require an infeasible amount of Liquidity Risk funding. That is a principal reason why a traditional central counterparty clearing house system to be unworkable.

VMAC achieves full Mark-to-Market Risk netting through its rules allowing VMAC to liquidate, at Mark-to-Market value, a defaulting party's in-the-money positions while at the same time paying off its out-of-the-money positions (see Table 3, page 18). This may require a counterparty to replace a defaulted contract for the physical delivery or purchase; but compensation is paid in the form of Liquidity Coverage, measured to compensate for the Liquidity Risk (see FIG. 3, page 17). The cost savings for the system are enormous. The use of this rule allows the bilateral collateral system to be converted to a multilateral system. This should free up as much as 80% of the collateral or credit exposure currently experienced in today's bilateral world in respect of Mark-to-Market Risk.

In FIG. 12, which illustrates simple netting, B may have an in-the-money PJM contract with A, C may have an in-the-money natural gas contract with B, and A may have an in-the-money COB contract with C. Because VMAC coverage is determined by marking the contract price to the market index for the particular product and delivery point, VMAC is able to offer a netted insurance package to the system. In the above example, if A defaults, VMAC insures that B is paid an amount up to the sum of $100 plus a Liquidity Coverage payment; the contract AC is replaced and C settles the mark-to-index at no more than $50 less a Liquidity Coverage payment. Under the VMAC system, collateral requirements are greatly reduced due to the ability to net credit exposures (in the simple case shown at right a total potential collateral requirement of $210 is reduced to a total insurance coverage requirement of $50).

Actual Mark-to-Index netting is far more powerful because of the number of participants. With 15 equal participants, the netting will reduce the Mark-to-Index exposure by an expected 80% compared with a bilateral system, regardless of the products covered.

Liquidity Risk is also measured and recognized by most traders today in the form of “Value at Risk” calculations associated with portfolios. Thus, Liquidity Coverage generally makes uniform the measurement of this risk and requires that the exposure be ascribed to the counterparty that is responsible for the risk. The VMAC system has specific Liquidity Coverage algorithms described above. However, the Core Group could alter or even eliminate the coverage from the VMAC system if it desires (although, it is believed that the rating agencies and other analysts should be consulted to vet the approach to Liquidity Risk in order to improve the environment for share value).

The VMAC rules are designed to allow for efficient treatment of Liquidity Risk as well. The rules relating to Liquidity Risk, described above in Table 3, permit the reconstitution of a defaulting parties positions among counterparties at correlated prices. This adds to the other basic netting of Liquidity Risk. As a result, Liquidity Coverage is netted as follows:

There are three types of netting related to the exposure VMAC covers related to Liquidity Coverage: 1) netting resulting from the fact that, whereas both sides of a trade are insured for Liquidity, VMAC will never incur a loss on both sides of a single contract; 2) netting resulting from VMAC's ability to reassign trades in the event of a bankruptcy or other default; and 3) netting resulting from correlations between contract prices related to deliver point and time.

A. Net Liquidity Coverage on a Single Contract

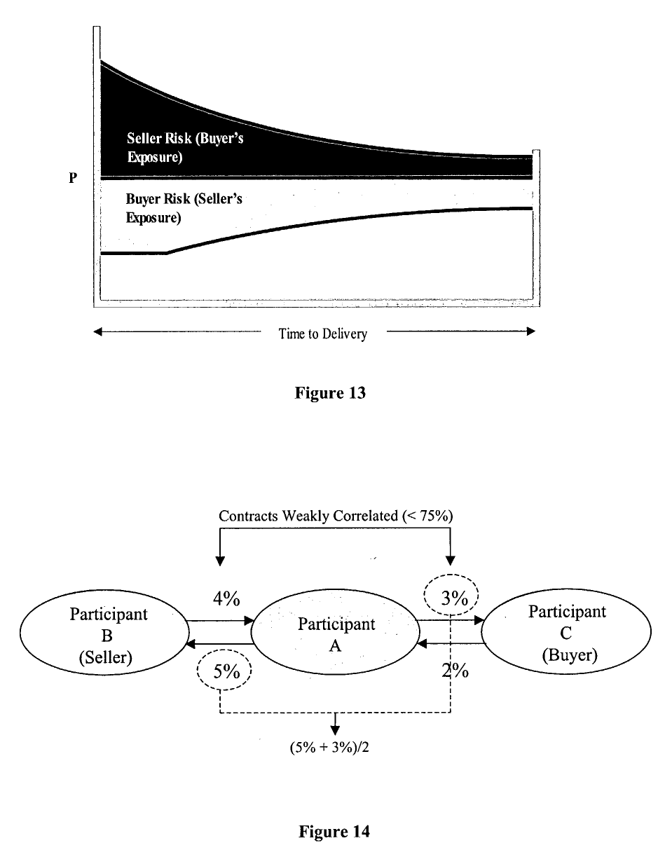

FIG. 13 shows the range of possible price movements (within a set number of standard deviations) within which VMAC will cover Liquidity Risk. The upper portion of this price range indicates additional exposure to a seller default (i.e., if a seller is in default, the replacement exposure is greater if the actual market price is higher). The lower portion of the price range indicates additional exposure to a buyer default (i.e., if a buyer defaults, the replacement exposure is greater if the actual market price is lower). While VMAC insures both sides of a contract, the actual exposure undertaken by VMAC can only be the greater of the exposures to the seller or buyer. This is because VMAC will only be covering one side of a trade in the event of a default (i.e.,—if both buyer and seller default, no payments are made by VMAC with respect to the contract). Thus, Liquidity Coverage can protect both sides fully, although requiring insurance in the amount of only the greater of the two Liquidity Risks.

A trader will, of course, have multiple contracts under the VMAC system. For contracts with weak correlation between the product prices, contracts cannot be off-set, and, consequently, VMAC charges a Net Liquidity charge to the Participant with respect to each such contract. As described above, the Net Liquidity Coverage equals the greater of the asymmetrical Liquidity Coverage provided to each side of the contract divided by two. On an aggregate basis, a Participant's Net Liquidity Coverage for multiple contracts in which the product prices are only weakly correlated, will be the sum of the greater Liquidity Coverage charges divided by two. As seen in FIG. 6 (below), Participant A will incur a Net Liquidity charge of 4% in the aggregate for the Liquidity Coverage VMAC provides on the two different contracts.

B. Net Net Liquidity Coverage of 100% Correlated Contracts

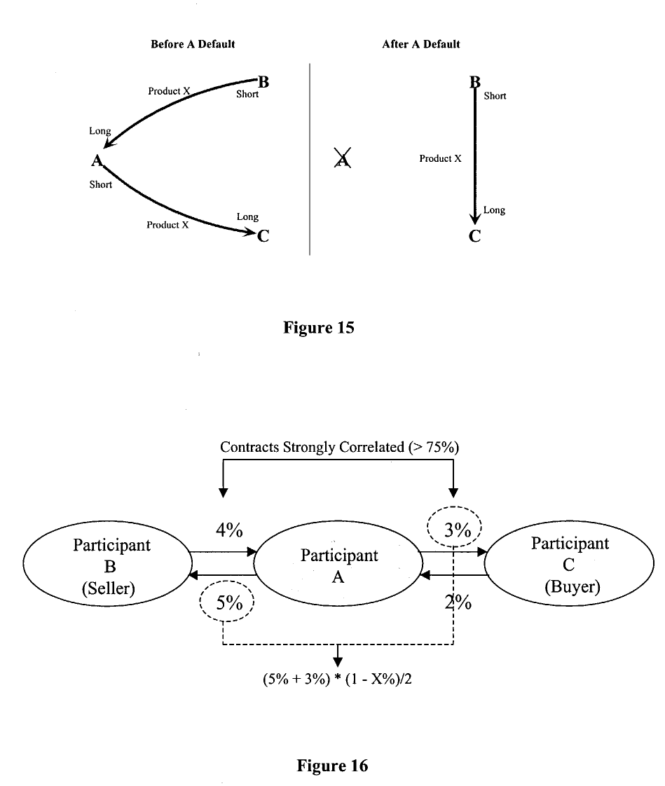

The VMAC coverage is provided under a set of basic rules governing the treatment of contract positions in the event of default, including bankruptcy. Among these rules are the right of VMAC to cover the contract positions of a defaulting party in the open market; this can be accomplished by reassigning the long and short positions in contracts for the same products among the non-defaulting counterparties (see FIG. 15). Therefore, if the products and delivery times and places are the same VMAC can calculate its liquidity exposure to an entity based on its net positions in a particular contract.

In addition to VMAC's ability to off-set 100% correlated contracts of a defaulting participant, the resulting Net Liquidity Charge can be netted a second time to achieve a “Net Net” Liquidity Charge. In this case, the Net Net Liquidity Charge applicable to A would be “0”.

C. Net Net Liquidity Coverage of Partially Correlated Contracts

For contracts involving products with strongly correlated prices (i.e., same Product and related delivery points and times), VMAC is also able to net the Liquidity Charge a second time. This is another version of the “Net Net” Liquidity Charge described above, applicable to contracts in which the product prices are strongly correlated, but less then 100%. This is made possible by the VMAC system rule requiring the non-defaulting Seller to deliver to the non-defaulting Buyer's delivery point at the Buyer's Mark-to-Index price, with the Seller being paid the defaulting Participant's “Net Net” Liquidity Coverage under both contracts. The defaulting Participant's “Net Net” Liquidity Coverage for correlated products equals (1-Correlation Factor) times (Net Liquidity Coverages in Seller/A and Buyer/A contracts). Participant A (see FIG. 8, below) is charged for “Net Net” Liquidity Coverage divided by two, which equals 0.8% if a Correlation Factor of 80% is used.

For illustration purposes, we have created the chart (below) which shows the varying amounts of Liquidity Charge payable by A based upon products, with different levels of price correlation, traded by the parties in FIGS. 14, 15 & 16. As is evidenced below, the VMAC system allows substantial savings via the netting of Liquidity Coverage for all but completely uncorrelated products.

TABLE 4
Netting of Liquidity Coverage based on correlations

| Product | Net Liquidity Coverage |
|---|---|
| Correlation | (Charge Basis) |
| Perfect | 0% |
| Strong (80% Correlation) | 0.8% |
| Weak | 4% |

VIII. VMAC Software and Systems

VMAC System

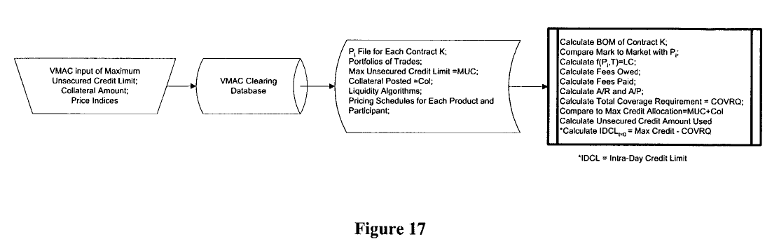

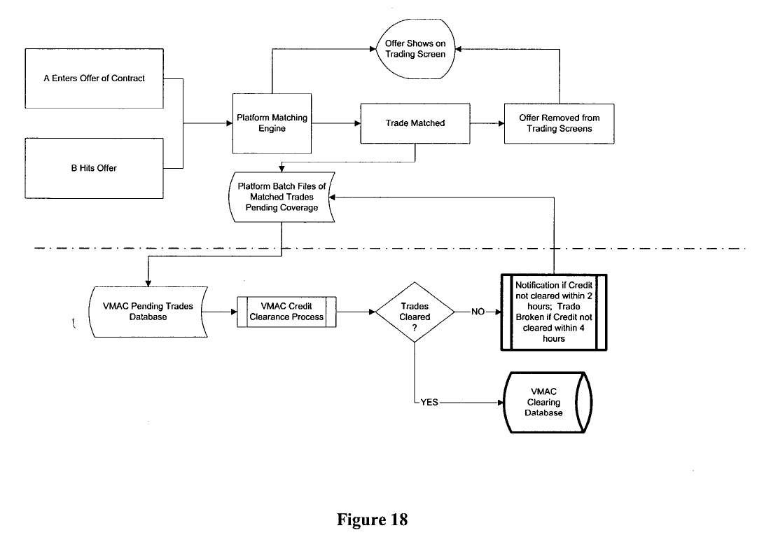

The VMAC system is designed to capture information representing bilateral contracts for the purchase and sale of electricity and natural gas, and financial contracts related to these physical markets. The system measures the exposures of a counterparty on a multilateral basis, utilizing Marks to Indices and Liquidity Coverage calculations related to the volatility of the underlying physical products (see Database Clearing Analytics in FIG. 17).

The system allows for capture of data (a) directly from counterparties (b) from brokers and (c) from electronic trading platforms. Once both sides of a trade are captured, the trade portions are matched and confirmed. The contract is then passed through a credit approval process and the VMAC credit assurance is available.

Electronic Platform Matched Trades

For trades matched on electronic trading platforms, VMAC simply receives the trade pre-confirmed, downloading matched “halves” through its API into the Pending Trades Database. In this case the trades are processed at intervals throughout the day, immediately passing through the confirmation filters and sent to the VMAC Credit Clearing Processes before being insured and written to the VMAC Clearing Database. (See Electronic Platform Format in FIG. 18.)

Trader-to-Trader and Brokered Trades

Trades generated directly between counterparties (Trader-to-Trader) and trades generated via a broker are processed similarly. Trade files of each party are downloaded to the VMAC Pending Trade Database periodically in batch format via the VMAC API, and processed by the VMAC Confirmation Processes. If the trades are matched without discrepancies, they are passed to the VMAC credit process. If the trades are credit cleared for both parties, they pass to the VMAC Clearing Database, and become covered contracts. If the matched trades do not clear the credit process, they remain in the Pending Trades Database a credit check and notification process is implemented.

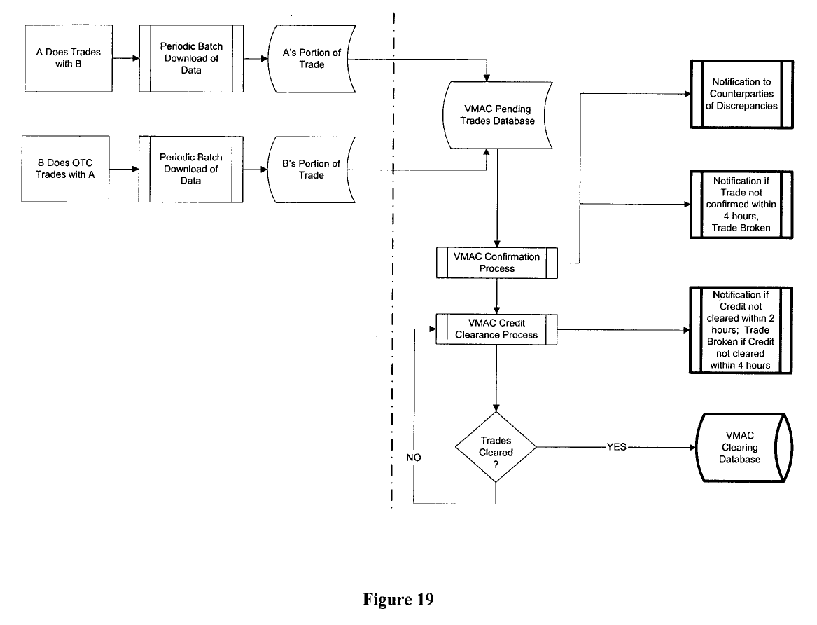

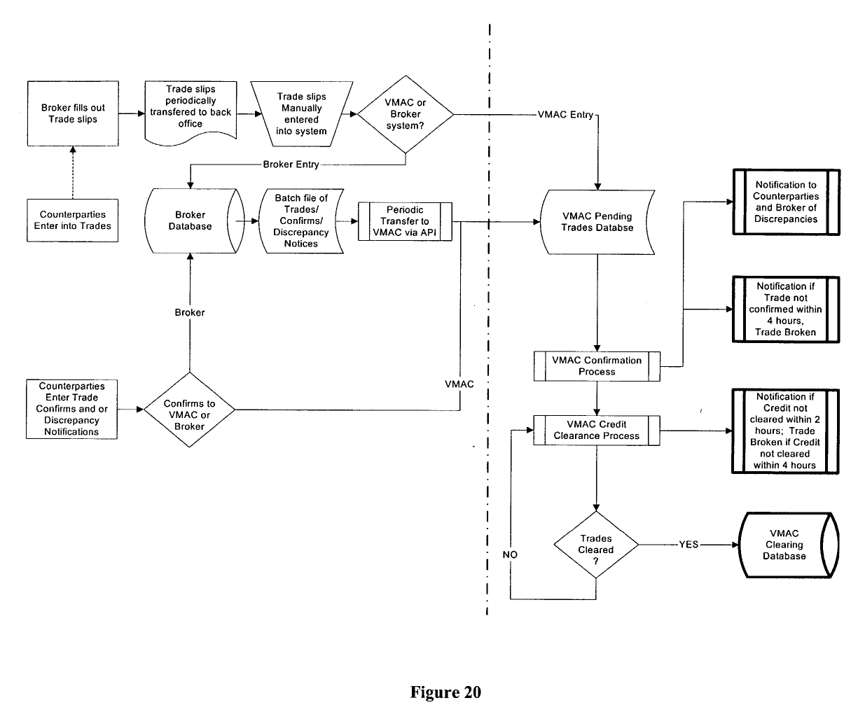

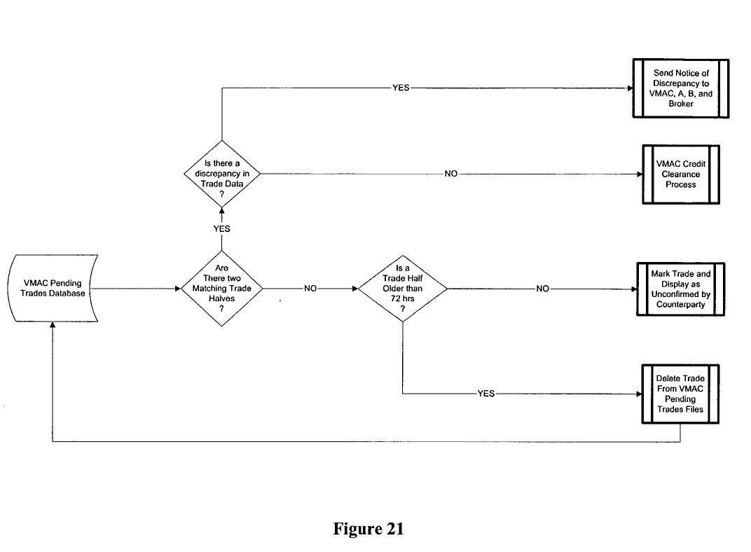

Counterparties may also manually enter confirmations of trades directly on the VMAC system, thereby utilizing the system itself as a back office confirmation platform; however, this is not necessary for utilization of the VMAC system. Counterparties will have access to online reporting of all confirmed and covered trades, as well as any trades in which there appear discrepancies between the confirmation files received from both counterparties. (See FIGS. 19 and 20.)

VMAC Confirmation Process

In the Confirmation Process, VMAC compares the trade records from each counterparty it has received in batch format at intervals earlier in the period. These trade records represent the “halves” of each of the counterparties' trades. As trades are processed, they are checked against all other pending trades by trade ID to search for the matching trade “half”.

If a matching trade ID is not found in the system, it is an unconfirmed contract, and the VMAC System determines how long VMAC has had the information in its Pending Trades Database; if the data has been in the files for longer than 4 hours, it is deleted, and notifications of such deletion is sent to both counterparties associated with the contract “half”. If the unmatched “half” has been in the System for less than 4 hours, it remains in the system and appears on a list of “Unconfirmed Trades” available to both counterparties online. (Please note that the 4 hour ‘holding’ period can be shortened or lengthened to satisfy market requirements.)

If a matching “half” is found in the system, the system compares all data for complete matching; if a discrepancy is found, a message is sent to that effect to all interested parties and the “half” is written to the Pending Trades Database, with a discrepancy flag on each non-matching field. Both “halves” remain in the System as unconfirmed trades, and as such are subject to deletion within 4 hours. Discrepancies can be adjusted by the counterparties manually through direct access to the Pending Trades Database via the VMAC Web Interface. Once both parties agree to the proper terms of the trade, and the appropriate “half” is adjusted by the party holding that “half”, then the trade is ready for processing and will clear the confirmation process.

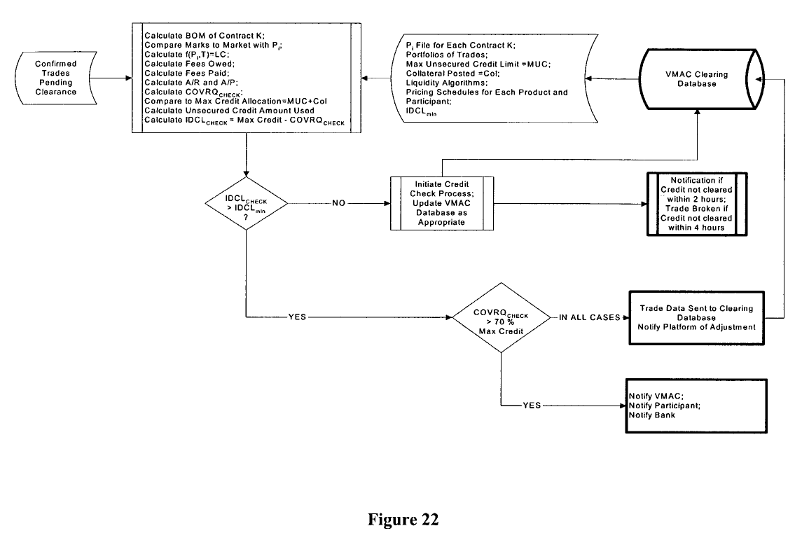

If trade ID's match and all data matches, the trade is confirmed and the two “halves” are sent as one trade to the VMAC Credit Clearance Process. (See FIG. 21.)

VMAC Credit Clearance Process

In the VMAC Credit Clearance Process, the VMAC systems analyze the impact of pending confirmed trades on the exposures to a participant, taking into account the participant's current portfolio. In this process, the VMAC Database Analytics are run with the current portfolio and with the pending confirmed trades. If the resulting Total Coverage requirement (related to multilaterally netted Marks to Index and Liquidity Coverages) of the analysis is greater than the available credit of the participant, none of the pending trades are accepted as VMAC covered trades, and a series of remedial steps are taken in order to clear the contracts. (See FIG. 22, below.)

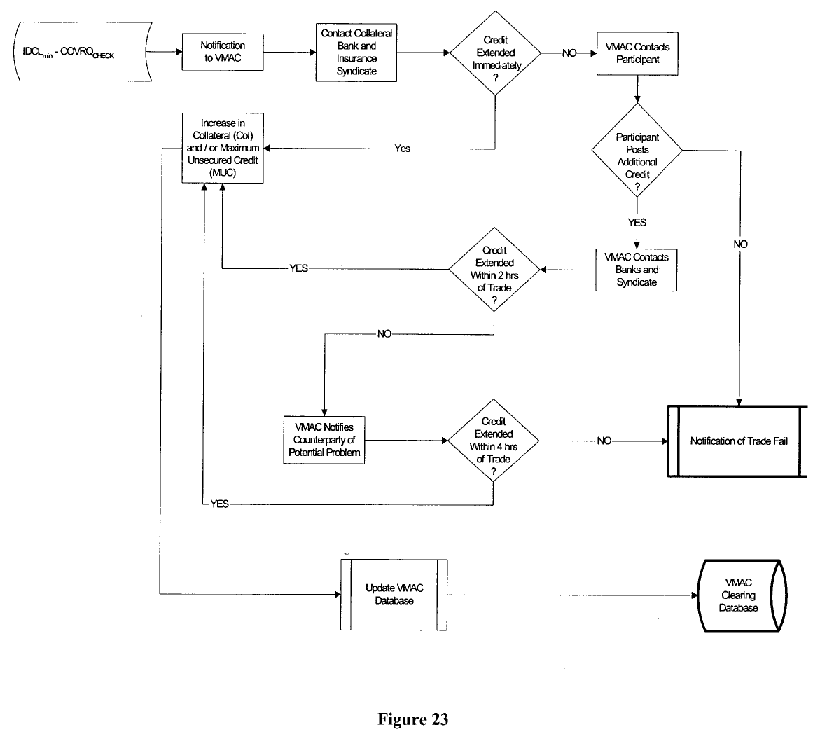

These steps include contacts with the participant's collateral bank in order to ascertain if an immediate increase in collateral is available; contact with the insurance syndicate to ascertain if an immediate increase in the maximum unsecured credit limit is available; and contact with the participant itself to ascertain if the posting of additional collateral is available. (See FIG. 23, below.)

It should be noted that each VMAC Participant will be notified of its Intra-Day Credit (IDCL) and usage at each time of recalculation. Special notification will be sent as the IDCL reaches specified percentages (30%, 20%, 10%) of the maximum credit allocation amounts. It is anticipated that each participant will manage its trading activity so as to minimize the occurence of unaccepted trades.

If increases are available in sufficient amounts, the VMAC databases are updated with the new figures, and the pending transactions will clear on the next analysis. If the credit issues are not resolved within two hours of the trade, VMAC notifies the exposed counterparty; if the credit issues are not resolved within four hours of the trade confirmation, the trade is not VMAC insured and reverts to a purely bilateral trade; notifications are sent to each counterparty, and the non-offending counterparty has the option to keep the trade on a purely bilateral basis, or break the trade.

IX. Additional Services

There are a number of activities that are related technologically and as a matter of business efficiency to credit and clearing.

Settlement. Cash flows can be made efficient by centralization. Cash can be netted and banking arrangements customized. Collateral deposits can be integrated into settlement of payments. The VMAC system is designed to accommodate settlement and there is a software system to support this service.

Confirmation. Confirmation of trades can be made part of the VMAC system so as to provide great economies of scale.

Scheduling. Scheduling is integral to delivery and performance on physical contracts. The VMAC system can interface with scheduling software and services that can be provided on a just-in-time basis so that sellers of gas and electricity can maintain maximum flexibility as long as possible while capturing the economies of tying credit, settlement, confirmation and delivery onto a seamless process.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might be said to fall therebetween.

What is claimed is:

1. A method for managing, on a pooled basis, the credit risk coverage of contract performance by contracting parties, comprising:
for each contracting party, establishing an aggregate maximum credit risk coverage for all contracts by that contracting party;
defining pools into which contracts from various contracting parties may be aggregated and defining a credit risk coverage limit for each of the pools;
when a contract is entered into, calculating the credit risk coverage associated with that contract for each contracting party and determining whether that credit risk coverage plus the risk coverage associated with all other existing contracts of that contracting party are within the maximum credit risk coverage for that contracting party; and
using the determination, deciding whether to accept the contract in the pool.

2. The method of claim 1, wherein the credit risk coverage is calculated as the difference between a contract's price and a fixed price.

3. The method of claim 1, wherein the credit risk coverage associated with a contract is calculated based on a percentage of the sale price to sellers and a percentage of the purchase price to buyers.

4. The method of claim 1, further comprising insuring counter-party risk for each contract in at least one of the pools.

5. The method of claim 1, further comprising updating the aggregate credit risk coverage on a periodic basis.

6. The method of claim 1, further comprising netting out contracts for a contracting party having the same quantity, delivery period and delivery location.

7. The method of claim 1, wherein the pools are established by delivery terms of the products or services.

8. The method of claim 1, wherein the pools are established by place of delivery of the products or services.

9. The method of claim 1, wherein the pools are established by time of delivery of the products or services.

10. The method of claim 1, further comprising defining the credit risk coverage limit for the pool as a percentage of the total risk of all the contracts in the pool.

11. The method of claim 1, further comprising establishing the credit risk coverage limit for at least one of the pools based on the concentration of exposure by the parties in the pool.

12. The method of claim 1, further comprising defining periodically the credit risk coverage limit for at least one of the pools based on the volume of contracts the pool.

13. The method of claim 4, further comprising limiting aggregate insurance claims payable for each pool to the credit risk coverage limit for each pool.

14. The method of claim 4, further comprising syndicating at least a portion of the insured counter-party risk in at least one of the pools.

15. The method of claim 1, wherein the contracts are for the delivery of electrical energy.

16. The method of claim 15, wherein the credit risk coverage is calculated as the difference between a contract's price and a fixed price.

17. The method of claim 15, wherein the credit risk coverage associated with a contract is calculated based on a percentage of the sale price to sellers and a percentage of the purchase price to buyers.

18. The method of claim 15, further comprising insuring counter-party risk for each contract in at least one of the pools.

19. The method of claim 15, further comprising updating the aggregate credit risk coverage on a periodic basis.

20. The method of claim 15, further comprising netting out contracts for a contracting party having the same quantity, delivery period and delivery location.

21. The method of claim 15, wherein the pools are established by delivery terms of the products or services.

22. The method of claim 15, wherein the pools are established by place of delivery of the products or services.

23. The method of claim 15, wherein the pools are established by time of delivery of the products or services.

24. The method of claim 15, further comprising defining the credit risk coverage limit for the pool as a percentage of the total risk of all the contracts in the pool.

25. The method of claim 15, further comprising establishing the credit risk coverage limit for at least one of the pools based on the concentration of exposure by the parties in the pool.

26. The method of claim 15, further comprising defining periodically the credit risk coverage limit for at least one of the pools based on the volume of contracts in the pool.

27. The method of claim 18, further comprising limiting aggregate insurance claims payable for each pool to the credit risk coverage limit for each pool.

28. The method of claim 18, further comprising syndicating at least a portion of the insured counter-party risk in at least one of the pools.

29. A delivery optimization system for trading a plurality of contracts for the purchase and sale of a product or service entered into between purchasers and sellers having a contract price, delivery period and delivery node traded on an electronic marketplace, virtual marketplace or established commodity exchange, comprising:
recording the actual source and delivery locations of the seller and purchaser holders of the contracts,
grouping contracts by product, delivery node and delivery date; and
matching buyers with sellers of contracts, prior to the time of delivery to reduce overall shipping cost.

30. The delivery optimization system of claim 29, wherein the matching is done when the contracts are no longer transferrable.

31. The delivery optimization system of claim 30, further comprising pre-determining a shipping price for each buyer and seller.

32. A trading system for products and services, comprising:
a contract for a specified product or service including quantity, quality specification, delivery location and delivery period;
a market participant qualification mechanism which establishes a credit risk coverage limit for each approved market participant;
a counter-party risk assurance system which provides each market participant with a specified degree of protection against counter-party risks in connection with purchase and sale contracts entered into by each market participant;
at least one trading mechanism for creating a market in contracts for the purchase and sale of one or more products and services by market participants; and
an administrative system for tracking the trading mechanism, counter-party risk assurance system, market participants and paired contracts for the purchase and sale of a product or service.

33. The trading system of claim 32, further comprising a receivables funding system for paying sellers receivables prior to the delivery date of a sale contract.

34. The trading system of claim 33, wherein a percentage of the receivables paid to a seller is deducted from the seller's aggregate maximum credit risk coverage until delivery is effected.

35. The trading system of claim 33, wherein the buyer counter-party risk of the contract associated with the receivables paid to a seller is insured in an additional amount.

36. The trading system of claim 35, wherein the additional amount is calculated taking into account a pool limit.
